(19) United States
(12) Patent Application Publication
(10) Pub. No.: US 2025/0308052 A1
(43) Pub. Date: Oct. 2, 2025

(54) SURFACE PROFILE ESTIMATION FOR AUTONOMOUS SYSTEMS AND APPLICATIONS

(71) Applicant: NVIDIA Corporation, Santa Clara, CA (US)

(72) Inventors: Tao FU, Jiangyin (CN); Kang WANG, Hefei (CN); Yue WU, Mountain View, CA (US); Gang PAN, Fremont, CA (US)

(73) Assignee: NVIDIA Corporation, Santa Clara, CA (US)

(21) Appl. No.: 18/642,097

(22) Filed: Apr. 22, 2024

(30) Foreign Application Priority Data
Mar. 29, 2024 (WO) PCT/CN2024/084891

(51) Int. Cl. G06T 7/62; G06T 7/593

(52) U.S. Cl. CPC G06T 7/62; G06T 7/593; G06T 2207/20221; G06T 2207/30252

(57) ABSTRACT

In various examples, systems and methods are disclosed relating to determining first track point heights of a ground surface for each of a plurality of frames of a disparity image based on a plane parallax algorithm, the first track point heights including previous track point heights of the ground surface for each of the at least one previous frame of the plurality of frames of the disparity image and current track point heights of the ground surface for the current frame of the plurality of frames of the disparity image and determining second track point heights by temporally fusing the current track point heights for the current frame and the previous track point heights for each of the at least one previous frame.

### CROSS-REFERENCE TO RELATED APPLICATIONS

The present application claims priority to International Application No. PCT/CN2024/084891, filed Mar. 29, 2024, the disclosure of which is incorporated herein by reference in its entirety.

### BACKGROUND

Modern vehicles—such as autonomous or semi-autonomous vehicles or machines—often rely on predicted road surface information to perform various operations, such as adjusting active suspension systems and/or adjusting speeds in order to improve the driving experience. Some conventional methods for determining road surface information include obtaining a three-dimensional (3D) representation of the road surface using monocular cameras, which, due to their inability to predict depth, often require extensive post-processing modules to provide consistent predictions. As a result, conventional monocular systems may be less accurate than desired. To account for this, stereo systems may be implemented to provide a more accurate depth estimation; however, even conventional stereo systems may not be able to adequately capture complex environmental conditions. As a result, these conventional methods produce less accurate or precise surface height information for road surfaces with low-texture or contrast. In addition, conventional post-processing modules or algorithms provide less temporally consistent predictions or indications of confidence for road or other driving surface predictions.

### SUMMARY

Some embodiments relate to a system including one or more processing circuits. The one or more processing circuits are configured to determine a disparity image for a plurality of frames by performing disparity estimation using at least a pair of images, the plurality of frames including a current frame and at least one previous frame, determine track points of the ego vehicle, determining first track point heights of the track points for each of the plurality of frames of the disparity image, the first track point heights including previous track point heights of the track points for each of the at least one previous frame of the plurality of frames of the disparity image and current track point heights of the track points for the current frame of the plurality of frames of the disparity image, determine second track point heights by temporally fusing the current track point heights for the current frame and the previous track point heights for each of the at least one previous frame, and perform one or more operations corresponding to the ego-vehicle based at least on the second track point heights.

Some embodiments relate to a system including one or more processing circuits. The one or more processing circuits are configured to determine a disparity image for each of a plurality of frames by performing disparity estimation using a pair of images, the pair of images being obtained using a stereo camera of an ego vehicle, and the plurality of frames including a current frame and at least one previous frame, determine first track point heights of the track points for each of the plurality of frames of the disparity image, the first track point heights including previous track point heights of track points for each of the at least one previous frame of the plurality of frames of the disparity image and current track point heights of the track points for the current frame of the plurality of frames of the disparity image, determine second track point heights by temporally fusing the current track point heights for the current frame and the previous track point heights for each of the at least one previous frame, and perform one or more operations associated with the ego vehicle based at least on the second track point heights.

Some embodiments relate to a system including one or more processing circuits. The one or more processing circuits are configured to determining first track point heights of a ground surface for each of a plurality of frames of a disparity image based on a plane parallax algorithm, the first track point heights including previous track point heights of the ground surface for each of the at least one previous frame of the plurality of frames of the disparity image and current track point heights of the ground surface for the current frame of the plurality of frames of the disparity image and determining second track point heights by temporally fusing the current track point heights for the current frame and the previous track point heights for each of the at least one previous frame.

Disclosed embodiments can be included in or provide data for a variety of different systems for generating and consuming road, driving, or otherwise navigable surface information (e.g., road surface height information), such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting virtual reality (VR) content, augmented reality (AR) content, and/or mixed reality (MR) content, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models—such as one or more LLMs, systems for hosting real-time streaming applications, systems for performing light transport simulation, systems for performing collaborative content creation for 3D assets, systems implemented at least partially using cloud computing resources, and/or other types of systems.

### BRIEF DESCRIPTION OF THE DRAWINGS

The present systems and methods for surface profile estimation in autonomous or semi-autonomous systems and applications are described in detail below with reference to the attached drawing figures, wherein:

FIG. 1 is a block diagram illustrating an example road surface scan (RSS) method for determining road surface information, in accordance with some embodiments of the present disclosure;

FIG. 2 is a block diagram illustrating an example pipeline 200 for generating disparity data, in accordance with some embodiments of the present disclosure;

FIG. 3 illustrates examples of a stereo rectified left frame and a stereo rectified right frame, in accordance with some embodiments of the present disclosure;

FIG. 4 illustrates examples of a raw depth map, a raw dense depth map, and a disparity map, in accordance with some embodiments of the present disclosure;

FIG. 5 is a method for training a neural network implementing disparity estimation, in accordance with some embodiments of the present disclosure;

FIG. 6 illustrates a field of view (FOV) of an ego vehicle with tracks defined by track points for which track point heights are determined, in accordance with some embodiments of the present disclosure;

FIG. 7 is a method for performing height estimation to determine track point heights, in accordance with some embodiments of the present disclosure;

FIG. 8 is a method for temporal fusion of track point heights determined for multiple frames to determine the temporally consistent track heights, in accordance with some embodiments of the present disclosure;

FIGS. 9-11 are methods for determining temporally consistent track heights, in accordance with some embodiments of the present disclosure;

FIG. 12 illustrates an example computing environment including a training system and an application system for training and deploying machine learning models, in accordance with some embodiments of the present disclosure;

FIG. 13A is an illustration of an example autonomous vehicle, in accordance with some embodiments of the present disclosure;

FIG. 13B is an example of camera locations and fields of view for the example autonomous vehicle of FIG. 13A, in accordance with some embodiments of the present disclosure;

FIG. 13C is a block diagram of an example system architecture for the example autonomous vehicle of FIG. 13A, in accordance with some embodiments of the present disclosure;

FIG. 13D is a system diagram for communication between cloud-based server(s) and the example autonomous vehicle of FIG. 13A, in accordance with some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

The present disclosure relates to homography-based road surface estimation for autonomous or semi-autonomous systems and applications. More specifically, the systems and methods described herein may relate to homography-based road surface estimation guided by stereo neural networks such as deep neural networks (DNNs) or, more specifically, convolutional neural networks (CNNs). In some embodiments, in a road surface scan (RSS) method, a neural network estimates 3D road surface information using a stereo system. The neural network can be trained (e.g., have one or more parameters updated over any number of iterations) from a training data set including different stereo pairs for different environmental conditions. The techniques described herein allow the neural network to generalize low-texture road surfaces from which accurate and robust road surface height estimations can be determined. The neural network can be updated using a scalable end-to-end light detection and ranging (LiDAR)-based ground truth data generation pipeline. Temporally consistent estimations can be obtained using a plane-parallax based single-frame height estimation algorithm and an ego motion-based multi-frame fusion algorithm. A confidence measure can be generated to indicate the reliability of the predictions. As a result, the homography-based road surface estimation techniques described herein have improved accuracy and robustness over conventional systems.

In some embodiments, ground heights of one or more points (e.g., checkpoints) along a predicted track (e.g., at least one of a predicted left track or a predicted right track) of an ego vehicle can be estimated. A predicted track is a path in which at least one wheel of the ego vehicle is predicted or expected to move. A predicted left track is a path in which a left front wheel or a left back wheel of the ego vehicle is predicted or expected to move. A predicted right track is a path in which a right front wheel or a right back wheel of the ego vehicle is predicted or expected to move.

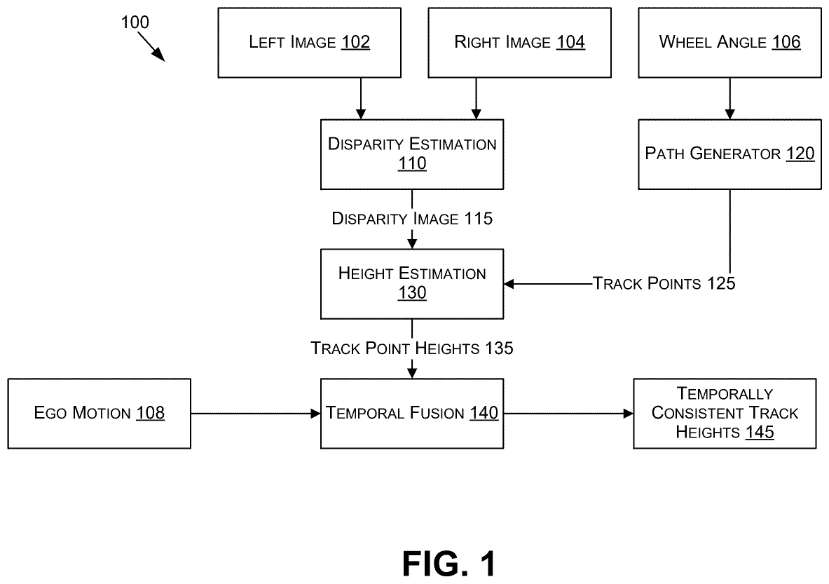

FIG. 1 is a block diagram illustrating an example road surface scan (RSS) method 100 for determining road surface or profile information, according to some embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

A left image 102 (e.g., a first image) and a right image 104 (e.g., a second image) are applied as inputs into disparity estimation 110 to determine a disparity image 115. In some examples, the left image 102 and the right image 104 are outputs from a stereo camera on the ego vehicle at a current frame (e.g., a current time step), such as a stereo raw left image or frame and a stereo raw right image or frame. In some examples, the first image and the second image are outputs from two different cameras with at least partially overlapping fields of view (FOV) on the ego vehicle at a same current frame. In some examples, first image and the second image are outputs from a same camera on the ego vehicle at two different frames (and two different timestamps), one of which being the current frame. While the embodiments herein are described with respect to stereo images or rectified stereo images, the same methods can be applicable to two images from the same camera captured at different timesteps. In some examples, the left image 102 and the right image 104 form a pair of images, an image pair, or a stereo pair.

In some examples, the left image 102 includes a left rectified image (e.g., a stereo rectified left image or frame), and the right image 104 includes a right rectified image (e.g., a stereo rectified right image or frame) at a current frame. The left rectified image and the right rectified image form a rectified stereo pair of images. For example, the right and left image outputs from a stereo camera at a current frame can be rectified to form the left rectified image right rectified image by transforming or aligning the right and left image outputs onto a common plane. In other words, each of the right rectified image and the left rectified image can provide information of the scene captured in the respective right and left image outputs on a common plane. The left image 102 and the right image 104 capture of view of the ego vehicle for each of a plurality of frames. That is, for each frame or time step, a left image 102 and a right image 104 can be captured or generated.

The disparity estimation 110 is a function, process, or module that generates, using the left image 102 and the right image 104, the disparity image 115 for three-dimensional (3D) metric measurement. The disparity image 115 provides 3D information relative to the height of the surface on which the ego vehicle travels. In some examples, the disparity estimation 110 includes a machine learning model or a neural network such as an attention concatenation volume network (ACVNet), which has a simple network structure and respectable precision in generating correct disparity images 115, as measured in End Point Error (EPE) in free space area.

In some examples, the disparity estimation 110 includes a cost-volume based neural network such as a convolutional neural network (CNN) or other type of DNN. In some examples, the disparity estimation 110 includes a combination of two complementary cost volumes that are correlation-based and concatenation-based. In some examples, the left image 102 and the right image 104 are applied as inputs to generate attention weights and an initial concatenation volume. The initial concatenation volume is provided to a filter to generate filtered results based on the attention weights to suppress redundant information and enhance matching-related information. The combination of the concatenation volume construction and the attention concatenation volume construction is referred to as attention concatenation volume construction. The filtered results are provided to a cost aggregation process to generate the disparity image 115.

In some examples, the disparity image 115 or disparity map is inversely proportional to the depth information, based on which the 3D information on the ground surface can be derived. In some examples, each pixel in the left image 102 is matched with or mapped to a corresponding pixel in the right image 104, where the pixel in the left image 102 and the corresponding pixel in the right image 104 form a pixel pair. A distance between pixels of each pixel pair is determined. The disparity image 115 includes a value indicative of the distance for each pixel matching the pixel pair.

Information regarding the current status of a locomotion system of the ego vehicle, such as a wheel angle 106 of wheels (or tires) of the ego vehicle, is applied as an input into a path generator 120 to generate track points 125. The path generator 120 is configured to generate instantaneous, stationary tracks using the current vehicle status, such as the wheel angle 106. A track generated by the path generator includes extrapolated or predicted contact points (e.g., the track points 125) on the ground surface that contact a wheel of the ego vehicle spanning from a current frame to multiple future frames (or future time steps). The track points 125 can be represented as points on a 2D image space representing the ground surface. The wheel angle 106 can include a current angle of each of at least one wheel or tire of the ego vehicle relative to a suitable reference line or a plane, e.g., the degree to which a wheel is turned in the current frame. The wheel angle 106 can be controlled by a human driver, an Artificial Intelligence (AI) driver (e.g., an autonomous driving software stack), or a combination thereof. The current wheel angle 106 can be determined by a control system (e.g., a computing system) of the ego vehicle. The control system on the ego vehicle can provide the wheel angle 106 as a value or parameter to the path generator 120 via a suitable internal connection or internal communication network in some examples. The control system (e.g., a cloud control system) can provide the wheel angle 106 to the path generator 120 via a suitable external connection or wireless communication network in some examples. In some examples, the path generator 120 can generate the track points 125 using a vehicle kinematic model. In some examples, the vehicle kinematic model includes a linear single-track model that generate the track points 125 using load-adaptive angle gradient and rear axle steering angle.

The disparity image 115 and the track points 125 are applied as inputs into height estimation 130 to generate track point heights 135 for a given frame (e.g., the current frame). The track points heights 135 (e.g., 3D height information in an x-y-z coordinate system) are generated for the track points 125 (e.g., 2D information in an x-y coordinate system corresponding to a surface on which the ego vehicle travels). That is, a track point height 135 is generated for a given track point 125.

The height estimation 130 is a function, process, or module that generates the track point heights 135 using a single frame module. In height estimation 130, a plane parallax algorithm can be used to estimate the ground elevation corresponding to the track point heights 135. The plane parallax algorithm assumes that the ground surface is planar (e.g., an x-y plane), and that a track point height 135 is a distance in the z direction from the ground surface, at a track point 125 on the ground surface.

The track point heights 135 for multiple frames (e.g., multiple time steps) and the ego motion 108 are applied as inputs into temporal fusion 140 to generate temporally consistent track heights 145. The track point heights 135 determined for two different frames can be inconsistent. For example, fast time-varying (e.g., abrupt) slope and offset errors can occur in the track point heights determined for multiple frames. This can be challenging for a control system of the ego vehicle to control its suspension system as the track points heights 135 can verify significantly within a short period of time. In some examples, the track point heights 135 can be determined for each of the left track (e.g., the track 612) and the right track (e.g., the track 614).

The temporal fusion 140 is a function, process, or module that generates the temporally consistent track heights 145 by fusing track point heights 135 for multiple frames based on the ego motion 108 to generate the temporally consistent track heights 145 with respect to the current frame. In some examples, the multiple frames includes the current frame and at least one previous frame (e.g., a previous time step). This allows the road profile generated using the track point heights 135 to be consistent, with slow time-varying slope and offset errors and small slope errors. The temporal fusion can be determined using an arbitrary virtual plane. In some examples, the temporally consistent track heights 145 can be determined for each of the left track (e.g., the track 612) and the right track (e.g., the track 614).

An active suspension system of the ego vehicle has a suspension traveler sensor to measure the suspension movement. The active suspension system can use this measurement signal to estimate the slope and offset error between the fusion result and the ideal result. For example, the control system of the ego vehicle can use the measurement signal to compensate the height error online. The active suspension system can use the relative height (e.g., the differences in heights) of different track points 125 is to minimize heave, pitch, and roll acceleration and control effort by controlling the suspension. The active suspension system can reduce the acceleration in a horizon window with respect to the current state, thus the active road profile may be less impactful.

In some examples, the ego motion 108 provides relative pose information of the ego vehicle. The ego motion 108 can provide consistency in fusing the track point heights 135 determined for multiple frames (e.g., multiple time steps). In some examples, the ego motion 108 can define relative motion of a camera pose of the stereo camera on the ego vehicle at a first frame (e.g., at a first timestep) relative to the second frame (e.g., at a second timestep). That is, given that the ego vehicle has moved from the first timestep to the second timestep, the reference position of the camera pose based on which the road profile (including the tracks and track points) is determined has also changed. The ego motion 108 (e.g., the relative motion of the camera pose) can be determined using a direction, speed, acceleration, and other parameters collected by the control system of the ego vehicle over the multiple frames. A median filter can be applied to aggregate the fusing of the track point heights 135 used for the multiple frames.

The temporally consistent track heights 145 can be used to adjust suspension system of the ego vehicle in real time. For example, the control system can control a suspension system of the ego vehicle to compensate for the temporally consistent track heights 145 by adjusting one or more of a shock absorber, damper, spring, spindle, coil, joint, axle, struct, control arm, sway bar, a shock, a subframe, and so on according to the temporally consistent track heights 145.

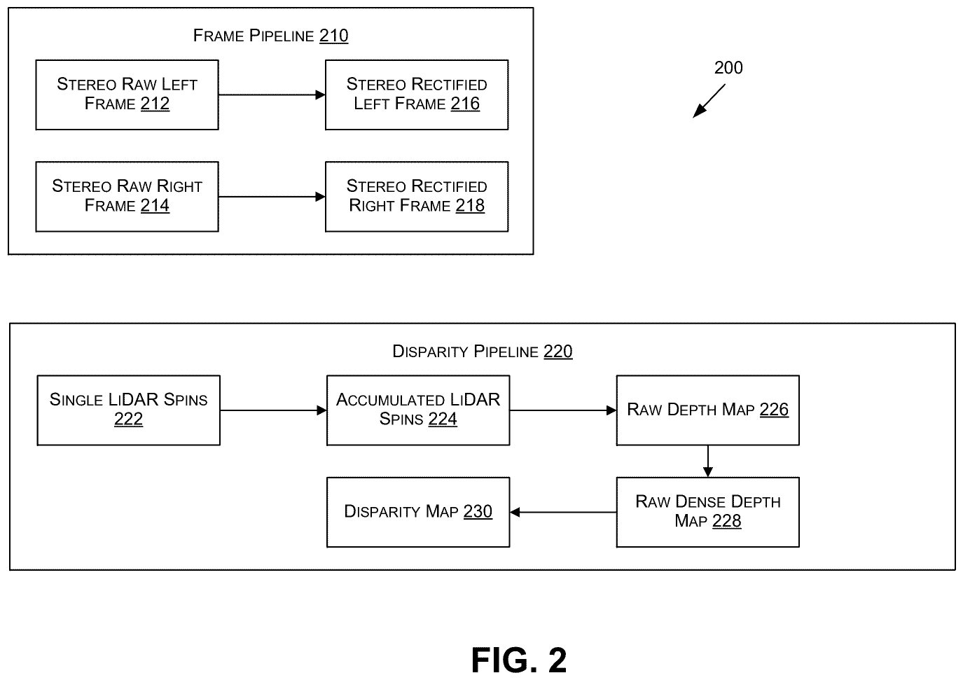

FIG. 2 is a block diagram illustrating an example pipeline 200 for generating disparity data, according to some embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The pipeline 200 for generating disparity data includes a frame pipeline 210 for generating image or frame data (e.g., the stereo rectified left frame 216 and the stereo rectified right frame 218) and a disparity pipeline 220 for generating a disparity map 230. The generated disparity map 230 for a given reference target frame can serve as the ground truth to train (e.g., update) the disparity estimation 110 (e.g., the ACVNet). The disparity pipeline 220 is used to generate training dataset usable during training of the disparity estimation 110 (e.g., as basis for comparison and loss functions).

In the frame pipeline 210, the stereo raw left frame 212 and the stereo raw right frame 214 are received from and provided by a stereo camera on the ego vehicle at a current frame. That is, the stereo raw left frame 212 and the stereo raw right frame 214 are the raw outputs of the stereo camera. The stereo raw left frame 212 and the stereo raw right frame 214 can be rectified to obtain the stereo rectified left frame 216 and the stereo rectified right frame 218. For example, the stereo raw left frame 212 and the stereo raw right frame 214 can be respectively transformed, aligned, or projected onto a common 2D plane to generate the stereo rectified left frame 216 and the stereo rectified right frame 218. The stereo rectified left frame 216 and the stereo rectified right frame 218 are different images capturing a same scene on a common plane. The left image 102 can be the stereo raw left frame 212 or the stereo rectified left frame 216. The right image 104 can be the stereo raw right frame 214 or the stereo rectified right frame 218.

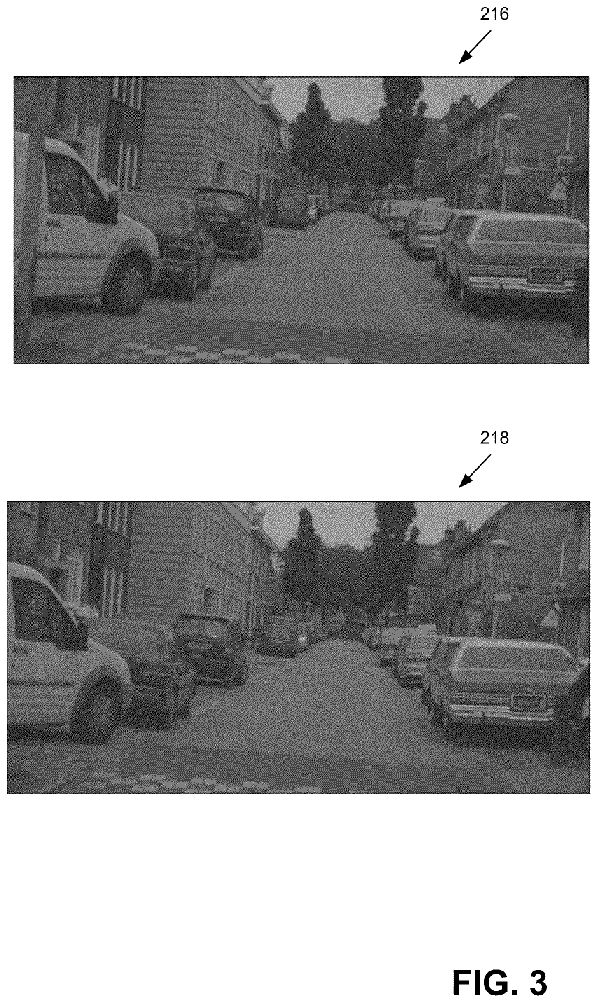

FIG. 3 illustrates examples of the stereo rectified left frame 216 and the stereo rectified right frame 218, according to some embodiments. Each of the stereo rectified left frame 216 and the stereo rectified right frame 218 is a 0.5-megapixel image have a size of 943 pixels by 529 pixels, for example. The stereo rectified left frame 216 and the stereo rectified right frame 218 are aligned to a common plane. Each of the stereo raw left frame 212 and the stereo raw right frame 214 based on which the stereo rectified left frame 216 and the stereo rectified right frame 218 are generated is an 8-megapixel image have a size of 2168 pixels by 3848 pixels, for example.

In the disparity pipeline 220, data (e.g., depth information such as point clouds) from single LiDAR spins 222 is obtained using a LiDAR sensor of the ego vehicle. Data from a single LiDAR spin 222 refers to data collected via moving the LiDAR sensor in a single spin, which can span multiple frames (e.g., multiple time steps) centered around or is configured to reference a target frame. For example, the target frame can be an earliest frame, a median frame, a latest frame, or another known frame of the multiple frames. The ego vehicle in dynamic motion can be at multiple locations (e.g., each location corresponds to a frame or timestep) during a single LiDAR spin.

Data for multiple single spins can be collected and accumulated, and can be referred to as data from accumulated LiDAR spins 224. The data from accumulated LiDAR spins 224 can span multiple frames (e.g., multiple periods each for a single spin) with multiple different target frames. One of the multiple different target frames (e.g., an earliest target frame, a median target frame, or a latest target frame) serves as the reference target frame for the raw depth map 226, the raw dense depth map 228, and the disparity map 230. The ego vehicle in dynamic motion can be at multiple locations (e.g., each location corresponds to a frame or timestep) during the accumulated LiDAR spins 224. Thus, the data from accumulated LiDAR spins 224 can provide dense depth information for a scene, given that data from one spin can provide depth information on objects that may have been occluded or may be beyond a detection range in data from another spin. The data from accumulated LiDAR spins 224 includes depth information such as point clouds collected from a LiDAR sensor in the accumulated LiDAR spins 224 thereof.

For example, the raw depth map 226 can be generated using the data from accumulated LiDAR spins 224. For example, the depth or 3D information such as point clouds from the accumulated LiDAR spins 224 can be projected to 2D image space of the raw depth map 226 using suitable projection or transformation functions, matrices, or AI techniques. Each pixel of the raw depth map 226 is assigned a value indicative of the depth or distance from the LiDAR sensor or other points on the ego vehicle, where such value is determined using the projection from the depth information from the accumulated LiDAR spins 224.

The raw depth map 226 can include holes corresponding to areas of the scene with inadequate depth data. A depth map densification module can generate the raw dense depth map 228 using the raw depth map 226 by infilling the holes with appropriate depth information, thus improving the density of the raw depth map 226. The raw depth map 226 and the raw dense depth map 228 can be collectively referred to as a depth map for the reference target frame. For example, the densification module can implement a densification algorithm and can generate the raw dense depth map 228 using the raw depth map 226.

The raw dense depth map 228 can be used to generate the disparity map 230 for the reference target frame. The disparity map 230 aligns with the field of view (FOV), pose (e.g., position and orientation on an ego vehicle), etc. of the stereo camera, the output of which is used to generate the disparity image 115. For example, distortion map can be used to covert the raw dense depth map 228 into the disparity map 230. The pose of the stereo camera used to output the frames 212 and 214, the camera parameters (e.g., the distance between the two lenses of the stereo cameras) of the stereo camera, the pose of the LiDAR sensor, and so on can be predetermined and used to translate the perspective or FOV of the raw dense depth map 228 to the perspective or FOV of the disparity image 115. The pixel values of the pixels in the raw dense depth map 228 can be inputted into a suitable distortion map (including translation functions, matrices, or AI techniques) provided based on the pose of the stereo camera, the camera parameters of the stereo camera, the pose of the LiDAR sensor, to generate the pixel values of the pixels in the disparity map 230. For example, the distortion map can be generated using the pose of the stereo camera, the camera parameters of the stereo camera, the pose of the LiDAR sensor.

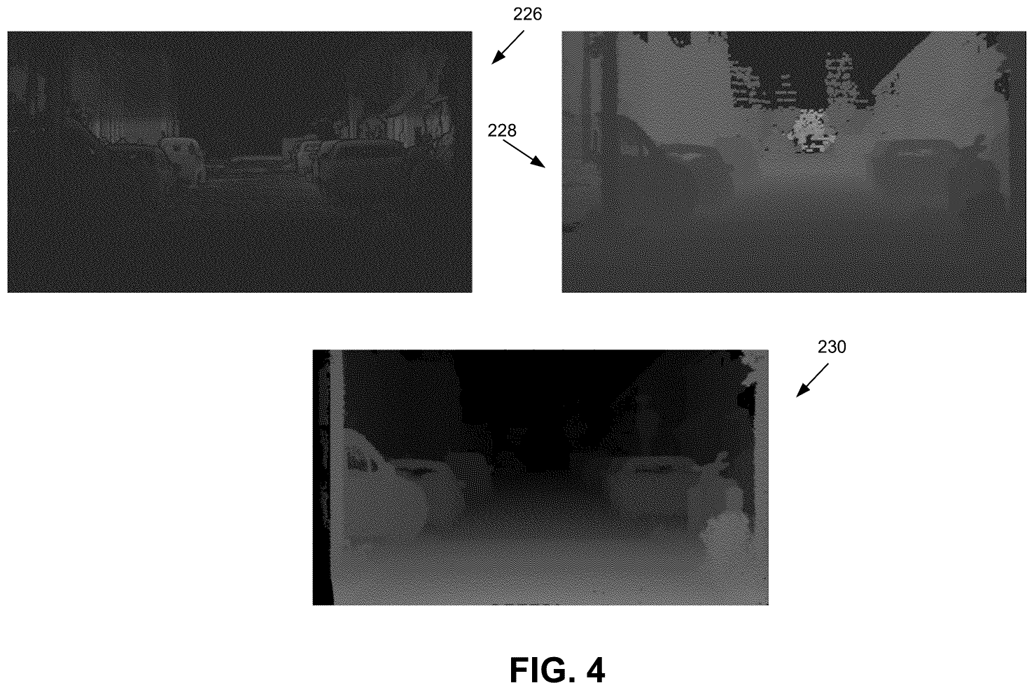

FIG. 4 illustrates examples of the raw depth map 226, the raw dense depth map 228, and the disparity map 230, according to some embodiments. Each of the raw depth map 226, the raw dense depth map 228 is an 8-megapixel image have a size of 2168 pixels by 3848 pixels, for example. The raw depth map 226 and the raw dense depth map 228 as shown are visualizations of the value at each pixel of the raw depth map 226 and the raw dense depth map 228 indicative of distance or depth of an object from a point such as the LiDAR sensor on the ego vehicle. The disparity map 230 is an image have a size of 943 pixels by 529 pixels, for example, which is the same size as that of the stereo rectified left frame 216 and the stereo rectified right frame 218.

In some examples, the disparity map 230 can serve as the ground truth to train the neural network configured to implement the disparity estimation 110. During training of the neural network that implements the disparity estimation 110, the neural network generates disparity image 115 using the stereo rectified left frame 216 and the stereo rectified right frame 218 for a given frame. The training system generates the disparity map 230 for a target frame, which is the same frame for which the disparity image 115 is generated for a same ego vehicle during a same drive. The frame of the stereo raw left frame 212 and the stereo raw right frame 214 and target frame of the depth information for the single LiDAR spins 222, the accumulated LiDAR spins 224, the depth maps 226 and 228 are the same. During a same drive, a stereo camera of an ego vehicle can capture the stereo rectified left frames 216 and the stereo rectified right frames 218 while a LiDAR sensor of the ego vehicle is capturing the depth information for the single LiDAR spins 222. Frames that align in time are used for training the neural network.

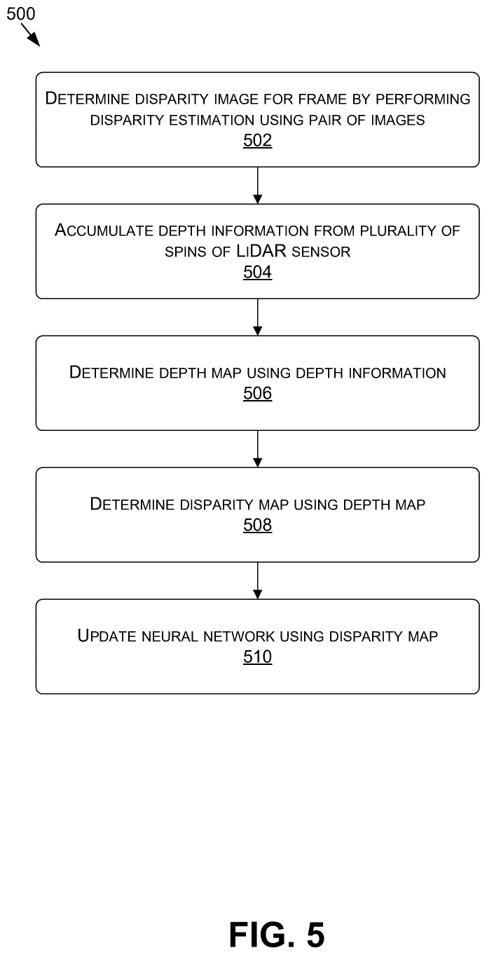

FIG. 5 is a method 500 for training (e.g., updating) a neural network implementing the disparity estimation 110, according to some embodiments. For instance, various functions can be carried out by at least one processor executing instructions stored in at least one memory. The method 500 can be embodied as computer-usable instructions stored on one or more computer storage media. The method 500 may be provided by a standalone application, a service or hosted service (standalone or in combination with another hosted service), or a plug-in to another product, to name a few. In addition, method 500 is described, by way of example, with respect to the systems of FIGS. 1-4. However, this method 500 may additionally or alternatively be executed by any one system, or any combination of systems, including, but not limited to, those described herein.

In some examples, the neural network implementing the disparity estimation 110 can include one or more of a CNN, DNN, ACVNet, and so on. The neural network can generate the disparity image 115 for a frame using one or more of the images 102 and 104, the frames 212 and 214, or the frames 216 and 218, in the manner described. The training system can generate a disparity map 230 for the same frame during a same drive of an ego vehicle, in the manner described. The disparity image 115 and the disparity map 230 can be compared, and the result is used to update the neural network.

At 502, the neural network implementing the disparity estimation 110 determines a disparity image 115 for a frame by performing the disparity estimation 110 using a pair of images (e.g., one or more of the images 102 and 104, the frames 212 and 214, or the frames 216 and 218). The pair of images are obtained using output from a stereo camera of an ego vehicle.

At 504, a training system accumulates the depth information from the plurality of spins 24 of a LiDAR sensor. At 506, the training system determines a depth map (e.g., the depth maps 226 and 228) using the depth information from the plurality of spins 224 of the LiDAR sensor. At 508, the training system determines the disparity map 230 using the depth map. At 510, the training system updates the neural network using the disparity map. For example, the training system can determine a loss of the disparity image 115 based on or with respect to the disparity map 230 and update the neural network using the loss.

The method 500 can be executed in multiple iterations for different frames of the disparity image 115 and disparity map 230, for different drives of a same ego vehicle, for different ego vehicles, and so on. Accordingly, the neural network implementing the disparity estimation can be updated using stereo image data and LiDAR depth data from multiple timesteps of a same drive, for different drives, and for different ego vehicles. The different ego vehicles can have different vehicle models with different poses of the stereo cameras, different camera parameters of the stereo cameras, and different poses of the LiDAR sensors. Alternatively, the different ego vehicles can have the same vehicle model with the same pose of the stereo cameras, the same camera parameters of the stereo camera, and the same pose of the LiDAR sensors. The different drives may have different weather and road conditions, different lighting (e.g., day versus night), different pedestrian scenarios, different traffic rules (for different regions), and so on.

In some examples, the loss includes a depth error measured as a difference between a value in the disparity image 115 and a value in the disparity map 230 for each pixel. In some examples, the loss includes a L1ₛₘₒₒₜₕ loss between value in the disparity image 115 and a value in the disparity map 230 for each pixel. In some examples, the loss includes a Laplacian on grid points loss to enforce second order smoothness. In some examples, the loss includes photometric loss between the left image or frame 102, 212, 216 and the right image or frame 104, 214, 218. The loss can include a total loss can be a sum or a weight sum of the combination of losses described herein. Each of such losses can include a mean error, mean squared error, or mean absolute error function. The training system can update by modifying one or more weights and parameters the neural network to minimize the loss.

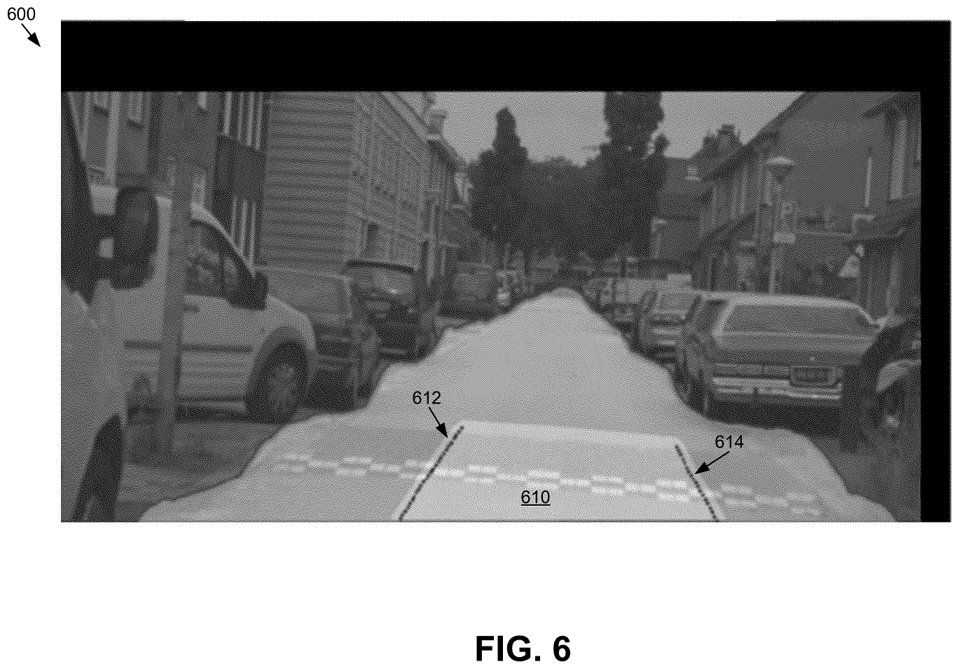

FIG. 6 illustrates a FOV 600 of an ego vehicle with tracks 612 and 614 defined by track points 125 for which track point heights 135 are determined, according to various embodiments. The FOV 600 shows the ground surface 610 with a left track 612 and a right track 614. The left track 612 can be defined by connecting the track points 125 for the left wheel or tire. The right track 614 can be defined by connecting the track points 125 for the right wheel or tire. The track point heights 135 are determined for each track point 125 along the tracks 612 and 614 to respectively adjust the suspension system for the left side of the ego vehicle and the right side of the ego vehicle at a current time step or a future time step. In some examples, the ground surface can be defined as an area between the tracks 612 and 614.

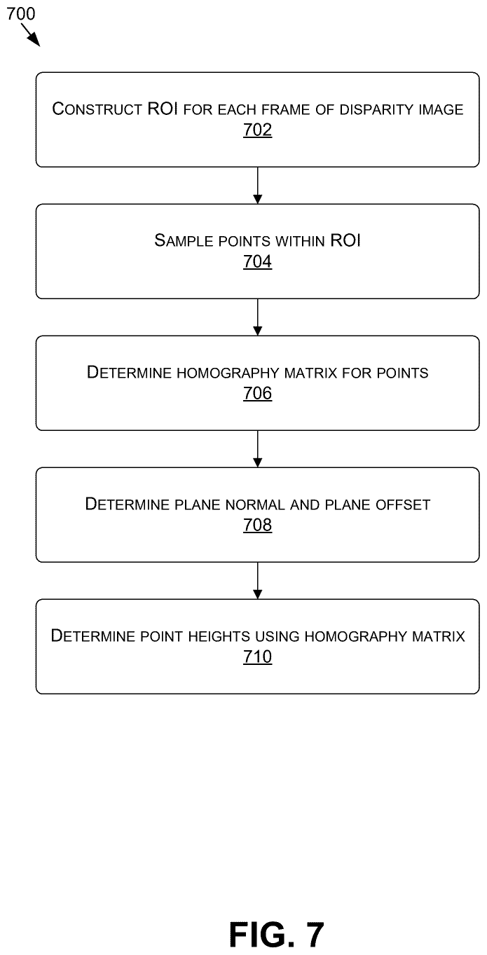

FIG. 7 is a method 700 or a plane parallax algorithm for performing height estimation 130 to determine the track point heights 135 using planar homography, according to some embodiments. For instance, various functions can be carried out by at least one processor executing instructions stored in at least one memory. The method 700 can be embodied as computer-usable instructions stored on one or more computer storage media. The method 700 may be provided by a standalone application, a service or hosted service (standalone or in combination with another hosted service), or a plug-in to another product, to name a few. In addition, method 700 is described, by way of example, with respect to the systems of FIGS. 1 and 6. However, this method 700 may additionally or alternatively be executed by any one system, or any combination of systems, including, but not limited to, those described herein.

At 702, a region of interest (ROI) for each of the plurality of frames of the disparity image 115 is constructed. The ROI defines an area corresponding to a future trajectory of the ego vehicle, and can generally include an area adjacent to the ego vehicle along a direction in which the ego vehicle is traveling. The ROI can be assumed to be flat or planar—the ROI corresponds to a plane defined in x-y axes. The ROI is a region for which a homography metric is to be determined. An example of the ROI includes the ground surface 610, which is the area between or bounded by the left and right tracks 612 and 614. In some examples, the ROI is defined or bounded by a free space region. In some examples, the ROI is defined or bounded by expanded convex hull of the track points 125 or expanded convex hull for each track 612 or 614 independently. In some examples, the ROI can further include areas along the direction of the track 612 or 614 to include more road areas to avoid bump region that may occupy a large portion of the ROI.

At 704, a plurality of points within the ROI are sampled. For example, a number (e.g., 3, 4, less than 10, less than 20, and so on) of points within a set of points U within the ROI can be randomly selected or sampled. A dense estimation on points within the ROI greater than the number is not needed to reduce computation resource and time requirement. The homography matrix can be estimated for those selected points within the ROI. In some examples, pixels of the areas nearby the selected points can constitute a majority of the pixels in the ROI. In some examples, uniformly sampling the points in the ROI can be biased toward regions near the sampled points. In some examples, the set of points U can include grid points on a virtual plane defined by Z_{rig}=0 to avoid biasing toward nearby regions.

At 706, a homography matrix for the plurality of points is determined. The homography matrix is a mapping between two planar regions. Thus, if a surface is non-planar, the mapping can be different from the disparity image 115. In some examples, the homography matrix can be determined using a Random Sample Consensus (RANSAC) algorithm. The homography matrix can transform pixel from a right image of a stereo pair to a left image in the stereo pair. An example homography matrix Hₛₜₑᵣₑₒ can be:

$${H}_{stereo} = K ( I - \frac{{tn}^{T}}{d} ) {K}^{- 1} , \qquad ( 1 )$$

where K is an intrinsic matrix, t is the translation vector [baseline; 0; 0], (n, d) is the plane normal and offset in a right camera, and T is a suitable parameter. In some examples, the homography matrix has only has 3 degrees of freedom (DoF) instead of 8. In some examples, to estimate the Hₛₜₑᵣₑₒ, homography estimation method in a suitable computer vision application (e.g., OpenCV) can be used to estimate 8 DoF homography matrix H_{general} and then project H_{general} to a closest Hₛₜₑᵣₑₒ. For example,

$${\tilde{H}}_{stereo} = I - \frac{{tn}^{T}}{d}$$

can be estimated given multiple corresponding feature pairs (pᵢ,pᵣ) in a left and right canonical camera coordinate system. In other examples, Hₛₜₑᵣₑₒ can be directly estimated using RANSAC.

At 708, a plane normal and a plane offset are determined. The plane normal is with respect to a plane of the ROI. The plane offset is an offset of the ROI with respect to the ego vehicle. In response to determining Hₛₜₑᵣₑₒ, the plane normal and plane offset at a given frame or time step t (Nₜ,dₜ) can be determined using a weighted average, for example, using:

$$( {N}_{t} , {d}_{t} ) = \frac{1 - α}{1 + α} * {\sum }_{i = 1}^{k} {α}^{i} {PropagateR}_{t - i} , {t}_{t - i} ( {N}_{t - i} , {d}_{t - i} ) + ( 1 - α ) * ( {N}_{c u r} , {d}_{c u r} ) , \qquad ( 2 )$$

where Propagate is a function transforming previous estimated plane (Nₜ₋ᵢ,dₜ₋ᵢ) to current pose (N_{cur},d_{cur}), Rₜ₋ᵢ,tₜ₋ᵢ is the relative pose between the current frame (cur) and (t−i)th frame, and a is a hyper parameter. (Nₜ,dₜ) can be used to construct a weighted-average version of Hₛₜₑᵣₑₒ.

At 710, a point height for each of the sampled points is determined using the homography matrix. In response to determining Hₛₜₑᵣₑₒ, the optical flow can be provided by the homography matrix. A difference between the homography optical flow and the optical flow determined using the disparity estimation 110 is a residual flow. If the ROI is planar, a residual flow of 0 indicates that the height of a selected point within the ROI is 0. The residual flow is positive if the height is above a ground surface, and negative if the height is below the ground surface. The track point heights 135 can be determined using the residual flow.

For example, a translation vector between the left and right camera of the stereo camera, a camera intrinsics matrix, a plane equation in a right camera coordinate system, a point in a right camera, a left image pixel coordinate, and a right image pixel coordinate can be defined. The projected left image position can be determined based on the homography, including the camera intrinsics matrix, the plane equation in the right camera coordinate system, the point in a right camera the left image pixel coordinate, and the right image pixel coordinate. The residual flow can be defined as a difference between the left image pixel coordinate and the projected left image position. A point height h can be determined according to the residual flow, the plane offset,

$$h = \frac{{r}_{x} d z}{f B} = \frac{{r}_{x} d}{disp a r i t y} , \qquad ( 3 )$$

where rₓ is the residual flow, d is plane offset, and disparity is an output (e.g., the disparity image 115) of the disparity estimation.

As compared to conventional methods in which the height of a track point is estimated in 3D space, the method 700 directly estimates the height in disparity space, which is the 2D depth image. In the method 700, the ROI is determined using the disparity image 115. The sampled points in the ROI and the application of the homography matrix on those points, along with the subsequent processes of determining the plane normal, the plane offset, and the height estimation are all performed within the 2D space of the disparity image 115.

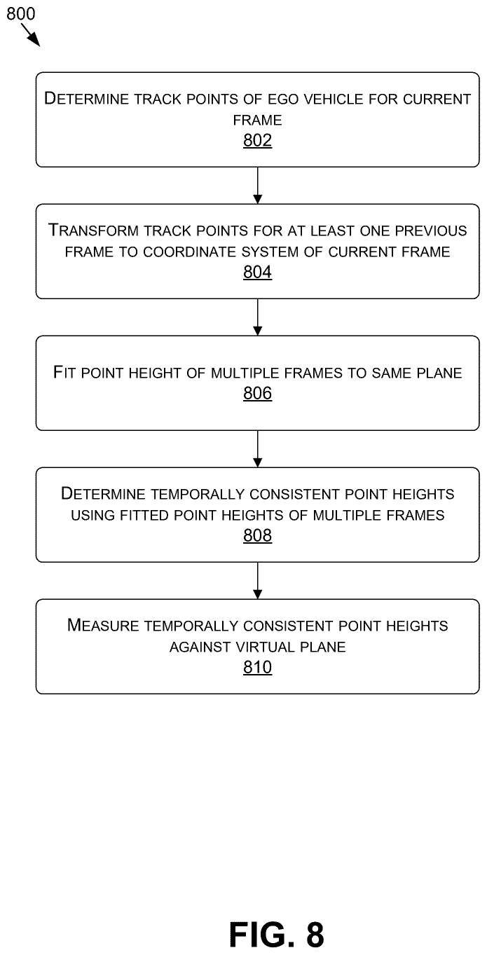

FIG. 8 is a method 800 for temporal fusion of track point heights 135 determined for multiple frames to determine the temporally consistent track heights 145, according to some embodiments. For instance, various functions can be carried out by at least one processor executing instructions stored in at least one memory. The method 800 can be embodied as computer-usable instructions stored on one or more computer storage media. The method 800 may be provided by a standalone application, a service or hosted service (standalone or in combination with another hosted service), or a plug-in to another product, to name a few. In addition, method 800 is described, by way of example, with respect to the systems of FIG. 1. However, this method 800 may additionally or alternatively be executed by any one system, or any combination of systems, including, but not limited to, those described herein.

At 802, the track points 125 of the ego vehicle for a current frame or a current target frame is determined. For example, the tracks (e.g., the tracks 612 and 614) of the ego vehicle defined with respect to a current frame or time step can be obtained. The current frame can be at a timestamp k. The tracks can be generated on a virtual plane defined by Z_{rig}=0. A number (e.g., 73) points can be sampled on each track in the current rig coordinate system on which the tracks are defined. The current rig coordinate system can be represented by (xᵢ^{k},yᵢ^{k},zᵢ^{k}), i∈[0,73).

At 804, the track points 125 of the at least one previous frame or previous target frame are transformed into a coordinate system of the current frame. For example, n frames of a road profile can be transformed to the current rig coordinate system of the current frame. For each frame j∈[0,n), relative motion (e.g., the ego motion 108) defined by (ₖ₋ⱼRₖ, ₖ₋ⱼtₖ) can be used to transform track points (xᵢ^{k},yᵢ^{k},zᵢ^{k}) to (xᵢ^{k-j},yᵢ^{k-j},zᵢ^{k-j}) in the rig coordinate system of frame j. The track points (xᵢ^{k-j},yᵢ^{k-j},zᵢ^{k-j}) can be projected to the image in frame j. The height estimation 130 can be performed to estimate the point heights 135 (h) in each of the track point (xᵢ,hᵢ^{k-j}).

At 806, the track point heights 135 (e.g., the first track point heights) for the multiple frames (including the current frame and the previous frame) are fitted to a same plane. The point heights 135 from different multiple frames may not be directly fused as they are in different planes due to the slope and offset differences in height estimation 130. Thus, the track point heights 135 of each of the multiple frames is transformed to a same plane such that ground points have a same zero height. For example, for track point (xᵢ,hᵢ^{k-j}), i∈[0,73), slope and offset parameters (sₖ₋ⱼ,oₖ₋ⱼ) can be minimized in the following expression:

$${\sum }_{i = 0}^{72} {( {x}_{i} * {s}_{k - j} + {o}_{k - j} + {h}_{i}^{k - j} )}^{2} . \qquad ( 4 )$$

In other words, a linear least square minimization can be used to determine the parameters (sₖ₋ⱼ,oₖ₋ⱼ).

In some examples, the track points are classified into ground points and bump points, and slope/offset fitting are performed only on the ground points. The track points can be cut into two sections based on the local peak values. One section is completely ground, and the section with the minimum residual error when fitting a straight line is the ground.

At 808, the temporally consistent track point heights 145 (e.g., the second point heights) are determined using the fitted track point heights 135. For example, each point on the track now has multiple track point heights 130 from the multiple frames now aligned to the same track points. A median or mean value of the track point heights 130 from the multiple frames can be used as the point estimation of the height at each sampled point in the track.

At 810, the second track point heights are measured against a virtual plane. The plane defined by (n, d) in a current left camera coordinate system can be determined. The second track point heights are measured against a virtual plane by optimizing the nonlinear least square of:

$$Min {\sum }_{i = 0}^{72} {( \frac{{n}^{T} {p}_{i}}{\vert \vert n \vert \vert} + d - {h}_{i} )}^{2} , \qquad ( 5 )$$

where T and pᵢ are suitable parameters.

In some examples, a confidence level can be calculated as a standard deviation of the resulting temporally consistent track heights 145 obtained using multiple camera frames. For example, the temporally consistent track heights 145 of each of the plurality of frames (e.g., consecutive frames) are determined in the manner described herein. The standard deviation of the temporally consistent track heights 145 for the plurality of frames is determined, and the standard deviation can be associated with a current frame or at least one of the plurality of frames. A greater standard deviation indicates low confidence. For example, in response to determining that the standard deviation is greater than a threshold, the control system or suspension system of the vehicle can discard the temporally consistent track height 145 determined for the current frame (out of the plurality of frames used to determine the standard deviation). In response to determining that the standard deviation is less than a threshold, the control system or suspension system of the vehicle can use the temporally consistent track height 145 determined for the current frame. In some examples, the confidence value can be implemented as or used to determine a weight for a temporally consistent track height 145. The greater the weight of a temporally consistent track height 145, the greater the impact of the temporally consistent track height 145 on the control system or suspension system. For example, a first weight of a first temporally consistent track height 145 determined for a first current frame impacts at least one aspect of the suspension system of the vehicle (defined by a parameter). A second weight of a second temporally consistent track height 145 determined for a second current frame impacts the at least one aspect of the suspension system (defined by the parameter). In some examples in which the first weight is greater than the second weight, the first temporally consistent track height 145 modifies the at least one aspect of the suspension system (and the associated parameter) to a greater degree than that of the second temporally consistent track height 145.

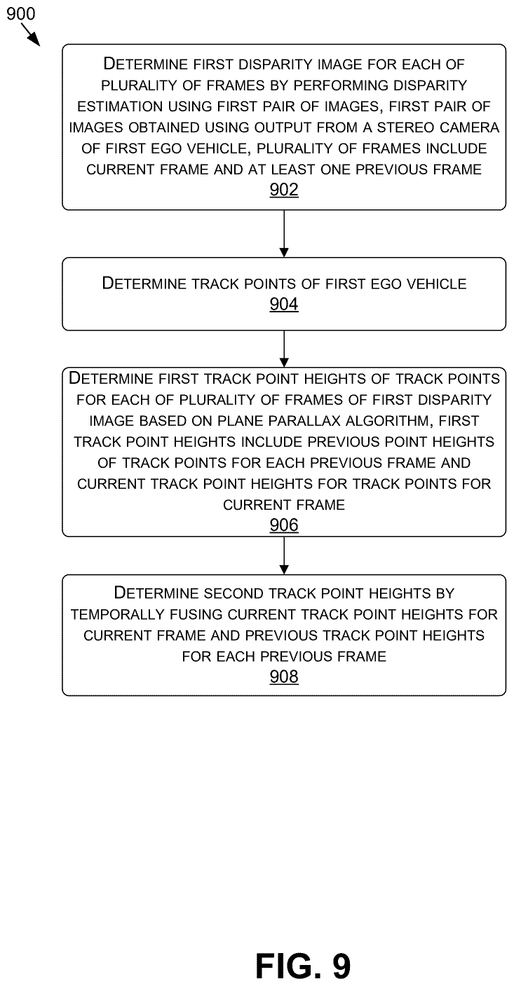

FIG. 9 is a method 900 for determining the temporally consistent track heights 145, according to some embodiments. For instance, various functions can be carried out by at least one processor executing instructions stored in at least one memory. The method 900 can be embodied as computer-usable instructions stored on one or more computer storage media. The method 900 may be provided by a standalone application, a service or hosted service (standalone or in combination with another hosted service), or a plug-in to another product, to name a few. In addition, method 900 is described, by way of example, with respect to the systems of FIGS. 1-8. However, this method 900 may additionally or alternatively be executed by any one system, or any combination of systems, including, but not limited to, those described herein.

At 902, at least one processor determines a disparity image (e.g., the disparity image 115 generated during deployment) for a plurality of frames by performing disparity estimation 110 using at least a pair of images (e.g., images 102 and 104, frames 212 and 214, or frames 216 and 218). In some examples, the pair of images is obtained using output from a stereo camera of an ego vehicle. The plurality of frames includes a current frame (or a current target frame) and at least one previous frame (or at least one previous target frame).

At 904, the at least one processor determines the track points 125 of the ego vehicle. The track points 125 can be for each of the plurality of frames. At 906, the at least one processor determines first track point heights (e.g., the track point heights 135) of the track points 125 for each of the plurality of frames of the disparity image. In some examples, the first track point heights are determined based on a plane parallax algorithm (e.g., the method 700). The first track point heights include previous track point heights 135 of the track points for each of the at least one previous frame of the plurality of frames of the disparity image and current track point heights 135 of the track points for the current frame of the plurality of frames of the disparity image.

At 908, the at least one processor determines second track point heights (e.g., the temporally consistent track heights 145) by temporally fusing the current track point heights 135 for the current frame and the previous track point heights 135 for each of the at least one previous frame. One or more operations corresponding to the ego-vehicle can be performed based at least on the second track point heights. For example, the control system can control a suspension system of the ego vehicle to compensate for the temporally consistent track heights 145 by adjusting one or more of a shock absorber, damper, spring, spindle, coil, joint, axle, struct, control arm, sway bar, a shock, a subframe, and so on according to the temporally consistent track heights 145.

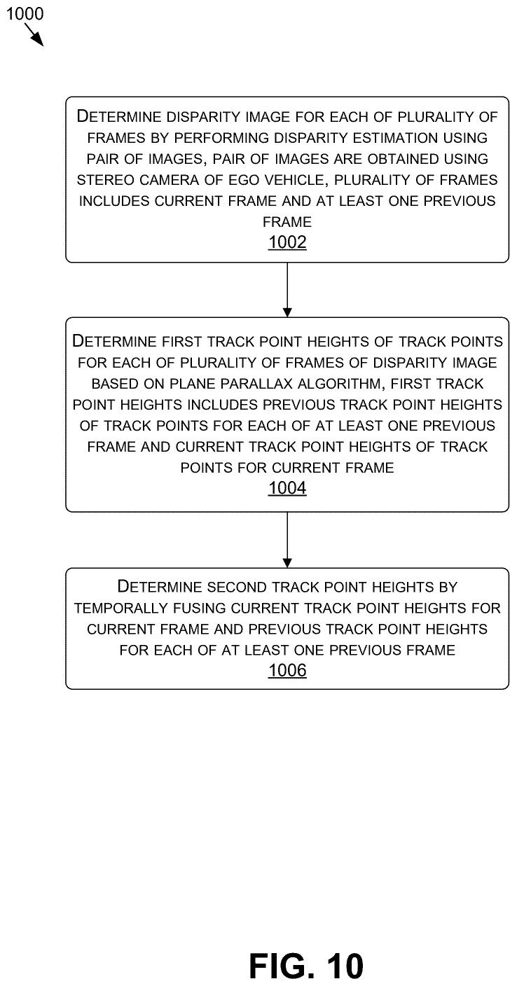

FIG. 10 is a method 1000 for determining the temporally consistent track heights 145, according to some embodiments. For instance, various functions can be carried out by at least one processor executing instructions stored in at least one memory. The method 1000 can be embodied as computer-usable instructions stored on one or more computer storage media. The method 1000 may be provided by a standalone application, a service or hosted service (standalone or in combination with another hosted service), or a plug-in to another product, to name a few. In addition, method 1000 is described, by way of example, with respect to the systems of FIGS. 1-8. However, this method 1000 may additionally or alternatively be executed by any one system, or any combination of systems, including, but not limited to, those described herein.

At 1002, at least one processor determines a disparity image (e.g., the disparity image 115 generated during deployment) for each of a plurality of frames by performing disparity estimation 110 using a pair of images (e.g., images 102 and 104, frames 212 and 214, or frames 216 and 218). The pair of images is obtained using output from a stereo camera of an ego vehicle. The plurality of frames includes a current frame (or a current target frame) and at least one previous frame (or at least one previous target frame).

At 1004, the at least one processor determines first track point heights (e.g., the track point heights 135) of the track points 125 for each of the plurality of frames of the disparity image based on a plane parallax algorithm (e.g., the method 700). The first track point heights include previous track point heights 135 of the track points for each of the at least one previous frame of the plurality of frames of the disparity image and current track point heights 135 of the track points for the current frame of the plurality of frames of the disparity image.

At 1006, the at least one processor determines second track point heights (e.g., the temporally consistent track heights 145) by temporally fusing the current track point heights 135 for the current frame and the previous track point heights 135 for each of the at least one previous frame. One or more operations corresponding to the ego-vehicle can be performed based at least on the second track point heights. For example, the control system can control a suspension system of the ego vehicle to compensate for the temporally consistent track heights 145 by adjusting one or more of a shock absorber, damper, spring, spindle, coil, joint, axle, struct, control arm, sway bar, a shock, a subframe, and so on according to the temporally consistent track heights 145.

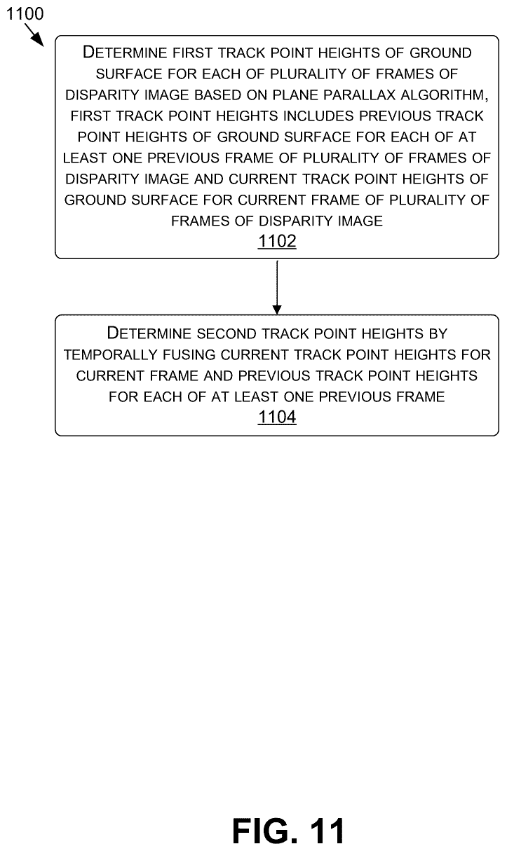

FIG. 11 is a method 1100 for determining the temporally consistent track heights 145, according to some embodiments. For instance, various functions can be carried out by at least one processor executing instructions stored in at least one memory. The method 1100 can be embodied as computer-usable instructions stored on one or more computer storage media. The method 1100 may be provided by a standalone application, a service or hosted service (standalone or in combination with another hosted service), or a plug-in to another product, to name a few. In addition, method 1100 is described, by way of example, with respect to the systems of FIGS. 1-8. However, this method 1100 may additionally or alternatively be executed by any one system, or any combination of systems, including, but not limited to, those described herein.

At 1102, at least one processor determines first track point heights (e.g., the track point heights 135) of a ground surface for each of the plurality of frames of a disparity image 115 based on a plane parallax algorithm (e.g., the method 700). The first track point heights include previous track point heights 135 of the track points for each of the at least one previous frame of the plurality of frames of the disparity image and current track point heights 135 of the track points for the current frame of the plurality of frames of the disparity image.

At 1104, the at least one processor determines second track point heights (e.g., the temporally consistent track heights 145) by temporally fusing the current track point heights 135 for the current frame and the previous track point heights 135 for each of the at least one previous frame. One or more operations corresponding to the ego-vehicle can be performed based at least on the second track point heights. For example, the control system can control a suspension system of the ego vehicle to compensate for the temporally consistent track heights 145 by adjusting one or more of a shock absorber, damper, spring, spindle, coil, joint, axle, struct, control arm, sway bar, a shock, a subframe, and so on according to the temporally consistent track heights 145.

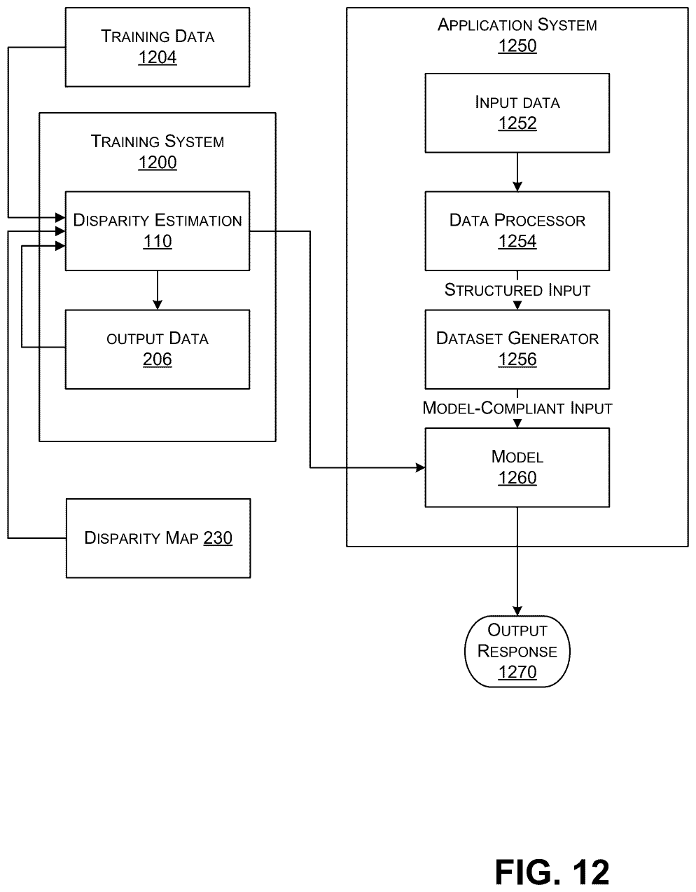

FIG. 12 illustrates an example computing environment including a training system 1200 and an application system 1250 for training and deploying machine learning models implementing disparity estimation 110, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The training system 1200 can train or update the neural network for implementing disparity estimation 110. In some embodiments, the neural network for implementing disparity estimation 110 includes one or more of CNN, DNN or ACVNet. A neural network can include an input layer, an output layer, and/or one or more intermediate layers, such as hidden layers, which can each have respective nodes.

The training system 1200 can train (e.g., update) the neural network for implementing disparity estimation 110 by applying as input the training data 204. The training data 204 can include one or more of the images 102 and 104, frames 212 and 214, or frames 216 and 218. The neural network for implementing disparity estimation 110 is trained or updated using the training data 204 to allow the neural network for implementing disparity estimation 110 to output the output data 206 (e.g., the disparity image 115).

The output data 206 and the disparity map 230 can be used to evaluate whether the neural network for implementing disparity estimation 110 has been trained/updated sufficiently to satisfy a target performance metric, such as a metric indicative of accuracy of the neural network for implementing disparity estimation 110 in generating outputs. For example, the training system 1200 can use a loss function as described herein to evaluate a condition for determining whether the neural network for implementing disparity estimation 110 is configured (sufficiently) to meet the target performance metric and/or to update the neural network for implementing disparity estimation 110. The condition can be a convergence condition, such as a condition that is satisfied responsive to factors such as an output of the function meeting the target performance metric or threshold, a number of training iterations, training of the neural network for implementing disparity estimation 110 converging, or various combinations thereof. For example, the function can be of the form of a mean error, mean squared error, or mean absolute error function to minimize the loss.

The training system 1200 can iteratively apply the training data 204 and the disparity map 230 to update the neural network for implementing disparity estimation 110, receive the feedback information 130 from the user system 220, evaluate the loss responsive to applying the training data 204 using the disparity map 230, and modify (e.g., update one or more weights and biases of) the neural network for implementing disparity estimation 110. The training system 1200 can modify the neural network for implementing disparity estimation 110 by modifying or updating at least one of a weight or a parameter of the neural network for implementing disparity estimation 110. The training system 1200 can evaluate the function by comparing an output of the function to a threshold of a convergence condition, such as a minimum or minimized cost threshold, such that the neural network for implementing disparity estimation 110 is determined to be sufficiently trained (e.g., sufficiently accurate in generating outputs) responsive to the output of the function being less than the threshold. The training system 1200 can output the neural network for implementing disparity estimation 110 responsive to the convergence condition being satisfied.

The application system 1250 can operate or deploy a model 1260 to generate the output response 1270 to input data 1252. Examples of the input data 1252 include the images 102 and 104. The input data 1252 can be provided using a stereo camera or two cameras. The application system 1250 can be a system to provide outputs (e.g., the output response 1270) based on the input data 1252. The application system 1250 can be implemented by or communicatively coupled with the training system 1200 via a suitable network.

The model 1260 can be or be received as the neural network for implementing disparity estimation 110, a portion thereof, or a representation thereof. For example, a data structure representing the neural network for implementing disparity estimation 110 can be used by the application system 1250 as the model 1260. The data structure can represent parameters of the trained the neural network for implementing disparity estimation 110, such as weights or biases used to configure the model 1260 based on the training of the neural network for implementing disparity estimation 110.

The data processor 1254 can be or include any function, operation, routine, logic, or instructions to perform functions such as processing the input data 1252 to generate a structured input, such as the images 102 and 104. The data processor 1254 can provide the structured input to a dataset generator 1256. The dataset generator 1256 can be or include any function, operation, routine, logic, or instructions to perform functions such as generating, based at least on the structured input, an input compliant with the model 1260. For example, the model 1260 can be structured to receive input in a particular format, such as a particular image format or file type, which may be expected to include certain types of values. The particular format can include a format that is the same or analogous to a format by which the training data 204 is applied to the neural network for implementing disparity estimation 110 to train that neural network. The dataset generator 1256 can identify the particular format of the model 1260, and can convert the structured input to the particular format.

The data processor 1254 and the dataset generator 1256 can be implemented as discrete functions or in an integrated function. For example, a single functional processing unit can receive the text prompts and kinematic constraints and can generate the input to provide to the model 1260 responsive to receiving the text prompts and kinematic constraints.

The model 1260 can generate an output response 1270 responsive to receiving the model-compliant input from the dataset generator 1256. The output response 1270 can include values corresponding to the disparity image 115, which can be provided to height estimation 130 to generate the track point heights 135 in the manner described.

Accordingly, systems and methods described herein can be included in or provide data for a variety of different systems, downstream applications, and specialized domains for generating and consuming road surface information (e.g., road surface height information), such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting VR content, AR content, and/or MR content, systems for performing digital twin operations, systems implemented using an edge device, systems incorporating one or more VMs, systems for performing synthetic data generation operations, systems implemented at least partially in a data center, systems for performing conversational AI operations, systems for performing generative AI operations, systems implementing one or more language models—such as one or more LLMs, systems for hosting real-time streaming applications, systems for performing light transport simulation, systems for performing collaborative content creation for 3D assets, systems implemented at least partially using cloud computing resources, and/or other types of systems. The embodiments described herein can be adapted for specific computational platforms, enhancing algorithmic development for data-intensive tasks across diverse industries. Thus, the disclosed embodiments can integrate into diverse applications enabling refined analytical computation and improved accuracy.

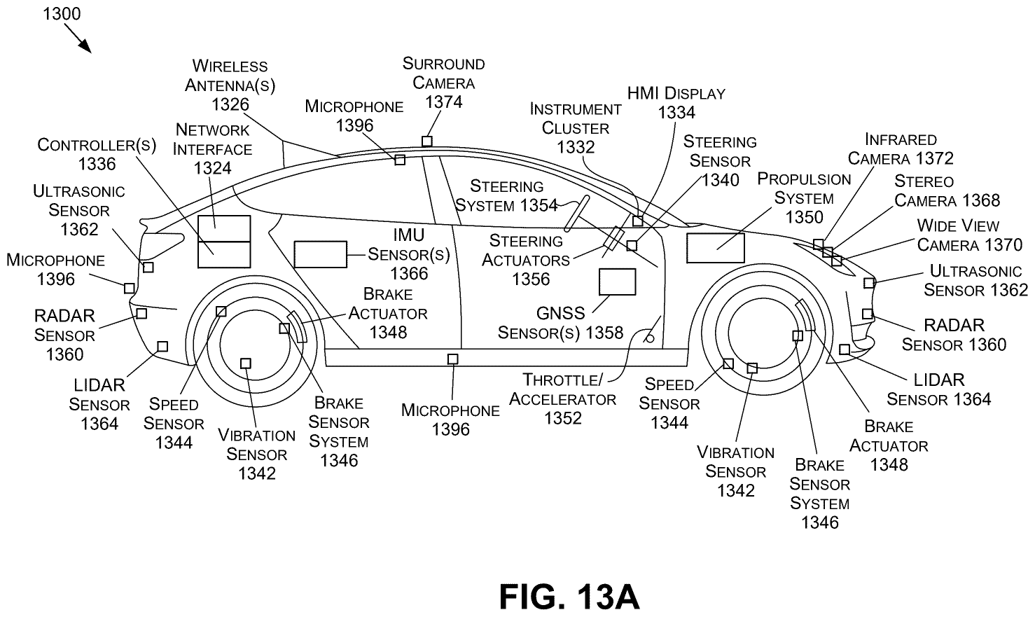

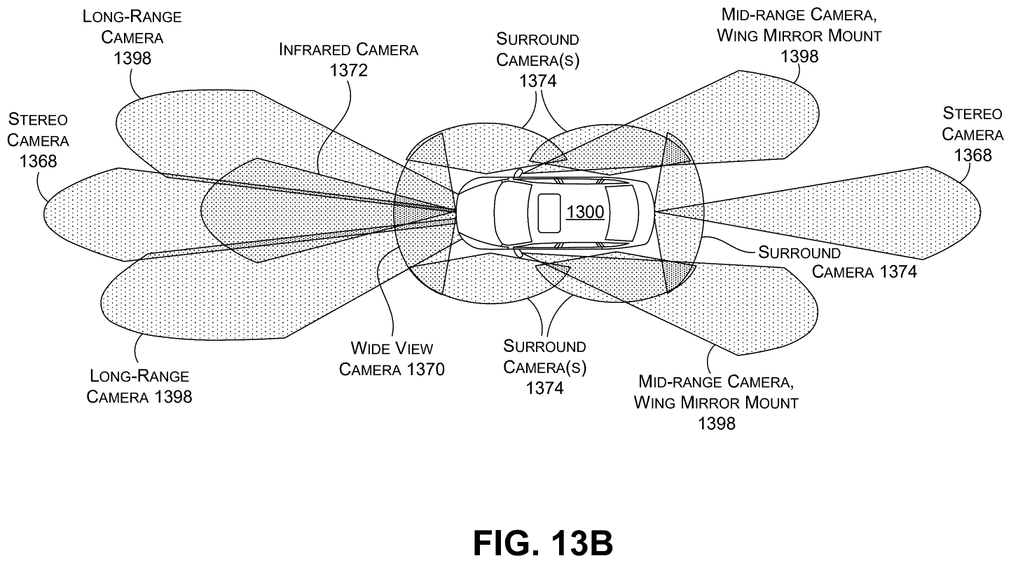

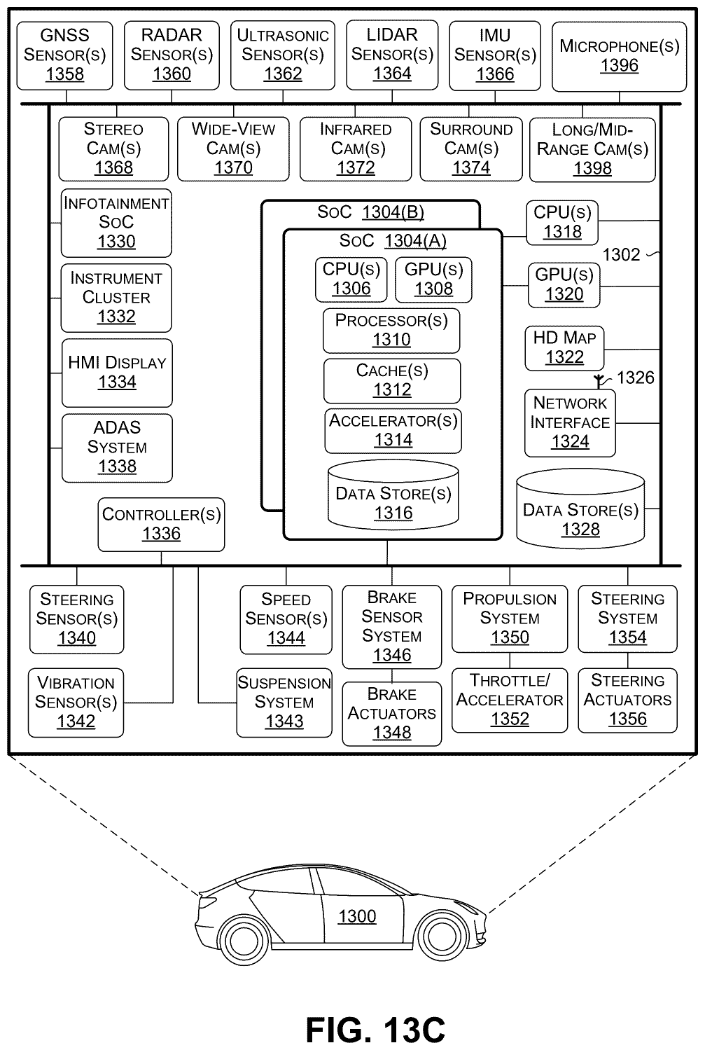

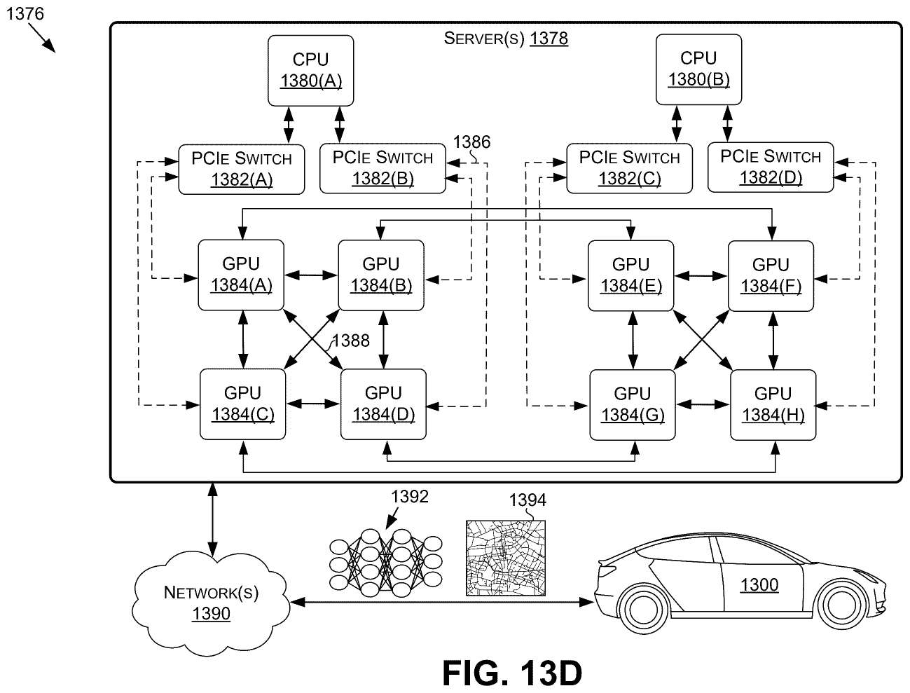

FIG. 13A is an illustration of an example autonomous vehicle 1300, in accordance with some embodiments of the present disclosure. The autonomous vehicle 1300 (alternatively referred to herein as the vehicle 1300 or ego vehicle) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1300 may be capable of functionality in accordance with one or more of Level 3-Level 5 of the autonomous driving levels. The vehicle 1300 may be capable of functionality in accordance with one or more of Level 1-Level 5 of the autonomous driving levels. For example, the vehicle 1300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1300 or other machine, such as being fully autonomous, being highly autonomous, being conditionally autonomous, being partially autonomous, providing assistive autonomy, being semi-autonomous, being primarily autonomous, or other designation.

The vehicle 1300 may include components such as a chassis, a vehicle body, wheels (e.g., 2, 4, 6, 8, 18, etc.), tires, axles, and other components of a vehicle. The vehicle 1300 may include a propulsion system 1350, such as an internal combustion engine, hybrid electric power plant, an all-electric engine, and/or another propulsion system type. The propulsion system 1350 may be connected to a drive train of the vehicle 1300, which may include a transmission, to enable the propulsion of the vehicle 1300. The propulsion system 1350 may be controlled in response to receiving signals from the throttle/accelerator 1352.

A steering system 1354, which may include a steering wheel, may be used to steer the vehicle 1300 (e.g., along a desired path or route) when the propulsion system 1350 is operating (e.g., when the vehicle is in motion). The steering system 1354 may receive signals from a steering actuator 1356. The steering wheel may be optional for full automation (Level 5) functionality.

The brake sensor system 1346 may be used to operate the vehicle brakes in response to receiving signals from the brake actuators 1348 and/or brake sensors.

Controller(s) 1336, which may include one or more system on chips (SoCs) 1304 (FIG. 13C) and/or GPU(s), may provide signals (e.g., representative of commands) to one or more components and/or systems of the vehicle 1300. For example, the controller(s) may send signals to operate the vehicle brakes via one or more brake actuators 1348, to operate the steering system 1354 via one or more steering actuators 1356, to operate the propulsion system 1350 via one or more throttle/accelerators 1352. The controller(s) 1336 may include one or more onboard (e.g., integrated) computing devices (e.g., supercomputers) that process sensor signals, and output operation commands (e.g., signals representing commands) to enable autonomous driving and/or to assist a human driver in driving the vehicle 1300. The controller(s) 1336 may include a first controller 1336 for autonomous driving functions, a second controller 1336 for functional safety functions, a third controller 1336 for artificial intelligence functionality (e.g., computer vision), a fourth controller 1336 for infotainment functionality, a fifth controller 1336 for redundancy in emergency conditions, and/or other controllers. In some examples, a single controller 1336 may handle two or more of the above functionalities, two or more controllers 1336 may handle a single functionality, and/or any combination thereof.

The controller(s) 1336 may provide the signals for controlling one or more components and/or systems of the vehicle 1300 in response to sensor data received from one or more sensors (e.g., sensor inputs). The sensor data may be received from, for example and without limitation, global navigation satellite systems (GNSS) sensor(s) 1358 (e.g., Global Positioning System sensor(s)), RADAR sensor(s) 1360, ultrasonic sensor(s) 1362, LIDAR sensor(s) 1364, inertial measurement unit (IMU) sensor(s) 1366 (e.g., accelerometer(s), gyroscope(s), magnetic compass(es), magnetometer(s), etc.), microphone(s) 1396, stereo camera(s) 1368, wide-view camera(s) 1370 (e.g., fisheye cameras), infrared camera(s) 1372, surround camera(s) 1374 (e.g., 360 degree cameras), long-range and/or mid-range camera(s) 1398, speed sensor(s) 1344 (e.g., for measuring the speed of the vehicle 1300), vibration sensor(s) 1342, an active suspension system 1343, steering sensor(s) 1340, brake sensor(s) (e.g., as part of the brake sensor system 1346), and/or other sensor types.

One or more of the controller(s) 1336 may receive inputs (e.g., represented by input data) from an instrument cluster 1332 of the vehicle 1300 and provide outputs (e.g., represented by output data, display data, etc.) via a human-machine interface (HMI) display 1334, an audible annunciator, a loudspeaker, and/or via other components of the vehicle 1300. The outputs may include information such as vehicle velocity, speed, time, map data (e.g., the High Definition (HD) map 1322 of FIG. 13C), location data (e.g., the vehicle's 1300 location, such as on a map), direction, location of other vehicles (e.g., an occupancy grid), information about objects and status of objects as perceived by the controller(s) 1336, etc. For example, the HMI display 1334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1300 further includes a network interface 1324 which may use one or more wireless antenna(s) 1326 and/or modem(s) to communicate over one or more networks. For example, the network interface 1324 may be capable of communication over Long-Term Evolution (LTE), Wideband Code Division Multiple Access (WCDMA), Universal Mobile Telecommunications System (UMTS), Global System for Mobile communication (GSM), IMT-CDMA Multi-Carrier (CDMA2000), etc. The wireless antenna(s) 1326 may also enable communication between objects in the environment (e.g., vehicles, mobile devices, etc.), using local area network(s), such as Bluetooth, Bluetooth Low Energy (LE), Z-Wave, ZigBee, etc., and/or low power wide-area network(s) (LPWANs), such as LoRaWAN, SigFox, etc.

FIG. 13B is an example of camera locations and fields of view for the example autonomous vehicle 1300 of FIG. 13A, in accordance with some embodiments of the present disclosure. The cameras and respective fields of view are one example embodiment and are not intended to be limiting. For example, additional and/or alternative cameras may be included and/or the cameras may be located at different locations on the vehicle 1300.

The camera types for the cameras may include, but are not limited to, digital cameras that may be adapted for use with the components and/or systems of the vehicle 1300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1300 (e.g., front-facing cameras) may be used for surround view, to help identify forward facing paths and obstacles, as well aid in, with the help of one or more controllers 1336 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a complementary metal oxide semiconductor (CMOS) color imager. Another example may be a wide-view camera(s) 1370 that may be used to perceive objects coming into view from the periphery (e.g., pedestrians, crossing traffic or bicycles). Although only one wide-view camera is illustrated in FIG. 13B, there may be any number (including zero) of wide-view cameras 1370 on the vehicle 1300. In addition, any number of long-range camera(s) 1398 (e.g., a long-view stereo camera pair) may be used for depth-based object detection, especially for objects for which a neural network has not yet been trained. The long-range camera(s) 1398 may also be used for object detection and classification, as well as basic object tracking.

Any number of stereo cameras 1368 may also be included in a front-facing configuration. In at least one embodiment, one or more of stereo camera(s) 1368 may include an integrated control unit comprising a scalable processing unit, which may provide a programmable logic (FPGA) and a multi-core micro-processor with an integrated Controller Area Network (CAN) or Ethernet interface on a single chip. Such a unit may be used to generate a 3D map of the vehicle's environment, including a distance estimate for all the points in the image. An alternative stereo camera(s) 1368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1368 may be used in addition to, or alternatively from, those described herein.

Cameras with a field of view that include portions of the environment to the side of the vehicle 1300 (e.g., side-view cameras) may be used for surround view, providing information used to create and update the occupancy grid, as well as to generate side impact collision warnings. For example, surround camera(s) 1374 (e.g., four surround cameras 1374 as illustrated in FIG. 13B) may be positioned to on the vehicle 1300. The surround camera(s) 1374 may include wide-view camera(s) 1370, fisheye camera(s), 360 degree camera(s), and/or the like. Four example, four fisheye cameras may be positioned on the vehicle's front, rear, and sides. In an alternative arrangement, the vehicle may use three surround camera(s) 1374 (e.g., left, right, and rear), and may leverage one or more other camera(s) (e.g., a forward-facing camera) as a fourth surround view camera.

Cameras with a field of view that include portions of the environment to the rear of the vehicle 1300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1398, stereo camera(s) 1368), infrared camera(s) 1372, etc.), as described herein.

FIG. 13C is a block diagram of an example system architecture for the example autonomous vehicle 1300 of FIG. 13A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1300 in FIG. 13C are illustrated as being connected via bus 1302. The bus 1302 may include a Controller Area Network (CAN) data interface (alternatively referred to herein as a CAN bus). A CAN may be a network inside the vehicle 1300 used to aid in control of various features and functionality of the vehicle 1300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1302 is described herein as being a CAN bus, this is not intended to be limiting. For example, in addition to, or alternatively from, the CAN bus, FlexRay and/or Ethernet may be used. Additionally, although a single line is used to represent the bus 1302, this is not intended to be limiting. For example, there may be any number of busses 1302, which may include one or more CAN busses, one or more FlexRay busses, one or more Ethernet busses, and/or one or more other types of busses using a different protocol. In some examples, two or more busses 1302 may be used to perform different functions, and/or may be used for redundancy. For example, a first bus 1302 may be used for collision avoidance functionality and a second bus 1302 may be used for actuation control. In any example, each bus 1302 may communicate with any of the components of the vehicle 1300, and two or more busses 1302 may communicate with the same components. In some examples, each SoC 1304, each controller 1336, and/or each computer within the vehicle may have access to the same input data (e.g., inputs from sensors of the vehicle 1300), and may be connected to a common bus, such the CAN bus.

The vehicle 1300 may include one or more controller(s) 1336, such as those described herein with respect to FIG. 13A. The controller(s) 1336 may be used for a variety of functions. The controller(s) 1336 may be coupled to any of the various other components and systems of the vehicle 1300, and may be used for control of the vehicle 1300, artificial intelligence of the vehicle 1300, infotainment for the vehicle 1300, and/or the like.

The vehicle 1300 may include a system(s) on a chip (SoC) 1304. The SoC 1304 may include CPU(s) 1306, GPU(s) 1308, processor(s) 1310, cache(s) 1312, accelerator(s) 1314, data store(s) 1316, and/or other components and features not illustrated. The SoC(s) 1304 may be used to control the vehicle 1300 in a variety of platforms and systems. For example, the SoC(s) 1304 may be combined in a system (e.g., the system of the vehicle 1300) with an HD map 1322 which may obtain map refreshes and/or updates via a network interface 1324 from one or more servers (e.g., server(s) 1378 of FIG. 13D).

The CPU(s) 1306 may include a CPU cluster or CPU complex (alternatively referred to herein as a CCPLEX). The CPU(s) 1306 may include multiple cores and/or L2 caches. For example, in some embodiments, the CPU(s) 1306 may include eight cores in a coherent multi-processor configuration. In some embodiments, the CPU(s) 1306 may include four dual-core clusters where each cluster has a dedicated L2 cache (e.g., a 2 MB L2 cache). The CPU(s) 1306 (e.g., the CCPLEX) may be configured to support simultaneous cluster operation enabling any combination of the clusters of the CPU(s) 1306 to be active at any given time.

The CPU(s) 1306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1308 may include an integrated GPU (alternatively referred to herein as an iGPU). The GPU(s) 1308 may be programmable and may be efficient for parallel workloads. The GPU(s) 1308, in some examples, may use an enhanced tensor instruction set. The GPU(s) 1308 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1308 may include at least eight streaming microprocessors. The GPU(s) 1308 may use compute application programming interface(s) (API(s)). In addition, the GPU(s) 1308 may use one or more parallel computing platforms and/or programming models (e.g., NVIDIA's CUDA).

The GPU(s) 1308 may be power-optimized for best performance in automotive and embedded use cases. For example, the GPU(s) 1308 may be fabricated on a Fin field-effect transistor (FinFET). However, this is not intended to be limiting and the GPU(s) 1308 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1308 to access the CPU(s) 1306 page tables directly. In such examples, when the GPU(s) 1308 memory management unit (MMU) experiences a miss, an address translation request may be transmitted to the CPU(s) 1306. In response, the CPU(s) 1306 may look in its page tables for the virtual-to-physical mapping for the address and transmits the translation back to the GPU(s) 1308. As such, unified memory technology may allow a single unified virtual address space for memory of both the CPU(s) 1306 and the GPU(s) 1308, thereby simplifying the GPU(s) 1308 programming and porting of applications to the GPU(s) 1308.

In addition, the GPU(s) 1308 may include an access counter that may keep track of the frequency of access of the GPU(s) 1308 to memory of other processors. The access counter may help ensure that memory pages are moved to the physical memory of the processor that is accessing the pages most frequently.

The SoC(s) 1304 may include any number of cache(s) 1312, including those described herein. For example, the cache(s) 1312 may include an L3 cache that is available to both the CPU(s) 1306 and the GPU(s) 1308 (e.g., that is connected both the CPU(s) 1306 and the GPU(s) 1308). The cache(s) 1312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1304 may include an arithmetic logic unit(s) (ALU(s)) which may be leveraged in performing processing with respect to any of the variety of tasks or operations of the vehicle 1300—such as processing DNNs. In addition, the SoC(s) 1304 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1306 and/or GPU(s) 1308.

The SoC(s) 1304 may include one or more accelerators 1314 (e.g., hardware accelerators, software accelerators, or a combination thereof). For example, the SoC(s) 1304 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1308 and to off-load some of the tasks of the GPU(s) 1308 (e.g., to free up more cycles of the GPU(s) 1308 for performing other tasks). As an example, the accelerator(s) 1314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1308, and by using an inference accelerator, for example, a designer may target either the DLA(s) or the GPU(s) 1308 for any function. For example, the designer may focus processing of CNNs and floating point operations on the DLA(s) and leave other functions to the GPU(s) 1308 and/or other accelerator(s) 1314.

The accelerator(s) 1314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1314 (e.g., the hardware acceleration cluster) may include a computer vision network on-chip and SRAM, for providing a high-bandwidth, low latency SRAM for the accelerator(s) 1314. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1304 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1366 output that correlates with the vehicle 1300 orientation, distance, 3D location estimates of the object obtained from the neural network and/or other sensors (e.g., LIDAR sensor(s) 1364 or RADAR sensor(s) 1360), among others.

The SoC(s) 1304 may include data store(s) 1316 (e.g., memory). The data store(s) 1316 may be on-chip memory of the SoC(s) 1304, which may store neural networks to be executed on the GPU and/or the DLA. In some examples, the data store(s) 1316 may be large enough in capacity to store multiple instances of neural networks for redundancy and safety. The data store(s) 1312 may comprise L2 or L3 cache(s) 1312. Reference to the data store(s) 1316 may include reference to the memory associated with the PVA, DLA, and/or other accelerator(s) 1314, as described herein.

The SoC(s) 1304 may include one or more processor(s) 1310 (e.g., embedded processors). The processor(s) 1310 may include a boot and power management processor that may be a dedicated processor and subsystem to handle boot power and management functions and related security enforcement. The boot and power management processor may be a part of the SoC(s) 1304 boot sequence and may provide runtime power management services. The boot power and management processor may provide clock and voltage programming, assistance in system low power state transitions, management of SoC(s) 1304 thermals and temperature sensors, and/or management of the SoC(s) 1304 power states. Each temperature sensor may be implemented as a ring-oscillator whose output frequency is proportional to temperature, and the SoC(s) 1304 may use the ring-oscillators to detect temperatures of the CPU(s) 1306, GPU(s) 1308, and/or accelerator(s) 1314. If temperatures are determined to exceed a threshold, the boot and power management processor may enter a temperature fault routine and put the SoC(s) 1304 into a lower power state and/or put the vehicle 1300 into a chauffeur to safe stop mode (e.g., bring the vehicle 1300 to a safe stop).

The processor(s) 1310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1310 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1310 may further include a real-time camera engine that may include a dedicated processor subsystem for handling real-time camera management.

The processor(s) 1310 may further include a high-dynamic range signal processor that may include an image signal processor that is a hardware engine that is part of the camera processing pipeline.

The processor(s) 1310 may include a video image compositor that may be a processing block (e.g., implemented on a microprocessor) that implements video post-processing functions needed by a video playback application to produce the final image for the player window. The video image compositor may perform lens distortion correction on wide-view camera(s) 1370, surround camera(s) 1374, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1308 is not required to continuously render new surfaces. Even when the GPU(s) 1308 is powered on and active doing 3D rendering, the video image compositor may be used to offload the GPU(s) 1308 to improve performance and responsiveness.

The SoC(s) 1304 may further include a mobile industry processor interface (MIPI) camera serial interface for receiving video and input from cameras, a high-speed interface, and/or a video input block that may be used for camera and related pixel input functions. The SoC(s) 1304 may further include an input/output controller(s) that may be controlled by software and may be used for receiving I/O signals that are uncommitted to a specific role.

The SoC(s) 1304 may further include a broad range of peripheral interfaces to enable communication with peripherals, audio codecs, power management, and/or other devices. The SoC(s) 1304 may be used to process data from cameras (e.g., connected over Gigabit Multimedia Serial Link and Ethernet), sensors (e.g., LIDAR sensor(s) 1364, RADAR sensor(s) 1360, etc. that may be connected over Ethernet), data from bus 1302 (e.g., speed of vehicle 1300, steering wheel position, etc.), data from GNSS sensor(s) 1358 (e.g., connected over Ethernet or CAN bus). The SoC(s) 1304 may further include dedicated high-performance mass storage controllers that may include their own DMA engines, and that may be used to free the CPU(s) 1306 from routine data management tasks.

The SoC(s) 1304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1304 may be faster, more reliable, and even more energy-efficient and space-efficient than conventional systems. For example, the accelerator(s) 1314, when combined with the CPU(s) 1306, the GPU(s) 1308, and the data store(s) 1316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1308.

In some examples, a CNN for facial recognition and vehicle owner identification may use data from camera sensors to identify the presence of an authorized driver and/or owner of the vehicle 1300. The always on sensor processing engine may be used to unlock the vehicle when the owner approaches the driver door and turn on the lights, and, in security mode, to disable the vehicle when the owner leaves the vehicle. In this way, the SoC(s) 1304 provide for security against theft and/or carjacking.

In another example, a CNN for emergency vehicle detection and identification may use data from microphones 1396 to detect and identify emergency vehicle sirens. In contrast to conventional systems, that use general classifiers to detect sirens and manually extract features, the SoC(s) 1304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1362, until the emergency vehicle(s) passes.

The vehicle may include a CPU(s) 1318 (e.g., discrete CPU(s), or dCPU(s)), that may be coupled to the SoC(s) 1304 via a high-speed interconnect (e.g., PCIe). The CPU(s) 1318 may include an X86 processor, for example. The CPU(s) 1318 may be used to perform any of a variety of functions, including arbitrating potentially inconsistent results between ADAS sensors and the SoC(s) 1304, and/or monitoring the status and health of the controller(s) 1336 and/or infotainment SoC 1330, for example.

The vehicle 1300 may include a GPU(s) 1320 (e.g., discrete GPU(s), or dGPU(s)), that may be coupled to the SoC(s) 1304 via a high-speed interconnect (e.g., NVIDIA's NVLINK). The GPU(s) 1320 may provide additional artificial intelligence functionality, such as by executing redundant and/or different neural networks, and may be used to train and/or update neural networks based on input (e.g., sensor data) from sensors of the vehicle 1300.

The vehicle 1300 may further include the network interface 1324 which may include one or more wireless antennas 1326 (e.g., one or more wireless antennas for different communication protocols, such as a cellular antenna, a Bluetooth antenna, etc.). The network interface 1324 may be used to enable wireless connectivity over the Internet with the cloud (e.g., with the server(s) 1378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1300 information about vehicles in proximity to the vehicle 1300 (e.g., vehicles in front of, on the side of, and/or behind the vehicle 1300). This functionality may be part of a cooperative adaptive cruise control functionality of the vehicle 1300.

The network interface 1324 may include a SoC that provides modulation and demodulation functionality and enables the controller(s) 1336 to communicate over wireless networks. The network interface 1324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1300 may further include data store(s) 1328 which may include off-chip (e.g., off the SoC(s) 1304) storage. The data store(s) 1328 may include one or more storage elements including RAM, SRAM, DRAM, VRAM, Flash, hard disks, and/or other components and/or devices that may store at least one bit of data.

The vehicle 1300 may further include GNSS sensor(s) 1358. The GNSS sensor(s) 1358 (e.g., GPS, assisted GPS sensors, differential GPS (DGPS) sensors, etc.), to assist in mapping, perception, occupancy grid generation, and/or path planning functions. Any number of GNSS sensor(s) 1358 may be used, including, for example and without limitation, a GPS using a USB connector with an Ethernet to Serial (RS-232) bridge.

The vehicle 1300 may further include RADAR sensor(s) 1360. The RADAR sensor(s) 1360 may be used by the vehicle 1300 for long-range vehicle detection, even in darkness and/or severe weather conditions. RADAR functional safety levels may be ASIL B. The RADAR sensor(s) 1360 may use the CAN and/or the bus 1302 (e.g., to transmit data generated by the RADAR sensor(s) 1360) for control and to access object tracking data, with access to Ethernet to access raw data in some examples. A wide variety of RADAR sensor types may be used. For example, and without limitation, the RADAR sensor(s) 1360 may be suitable for front, rear, and side RADAR use. In some example, Pulse Doppler RADAR sensor(s) are used.

The RADAR sensor(s) 1360 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1300 surroundings at higher speeds with minimal interference from traffic in adjacent lanes. The other two antennae may expand the field of view, making it possible to quickly detect vehicles entering or leaving the vehicle's 1300 lane.

Mid-range RADAR systems may include, as an example, a range of up to 1360 m (front) or 80 m (rear), and a field of view of up to 42 degrees (front) or 1350 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1300 may further include ultrasonic sensor(s) 1362. The ultrasonic sensor(s) 1362, which may be positioned at the front, back, and/or the sides of the vehicle 1300, may be used for park assist and/or to create and update an occupancy grid. A wide variety of ultrasonic sensor(s) 1362 may be used, and different ultrasonic sensor(s) 1362 may be used for different ranges of detection (e.g., 2.5 m, 4 m). The ultrasonic sensor(s) 1362 may operate at functional safety levels of ASIL B.

The vehicle 1300 may include LIDAR sensor(s) 1364. The LIDAR sensor(s) 1364 may be used for object and pedestrian detection, emergency braking, collision avoidance, and/or other functions. The LIDAR sensor(s) 1364 may be functional safety level ASIL B. In some examples, the vehicle 1300 may include multiple LIDAR sensors 1364 (e.g., two, four, six, etc.) that may use Ethernet (e.g., to provide data to a Gigabit Ethernet switch).

In some examples, the LIDAR sensor(s) 1364 may be capable of providing a list of objects and their distances for a 360-degree field of view. Commercially available LIDAR sensor(s) 1364 may have an advertised range of approximately 1300 m, with an accuracy of 2 cm-3 cm, and with support for a 1300 Mbps Ethernet connection, for example. In some examples, one or more non-protruding LIDAR sensors 1364 may be used. In such examples, the LIDAR sensor(s) 1364 may be implemented as a small device that may be embedded into the front, rear, sides, and/or corners of the vehicle 1300. The LIDAR sensor(s) 1364, in such examples, may provide up to a 120-degree horizontal and 35-degree vertical field-of-view, with a 200 m range even for low-reflectivity objects. Front-mounted LIDAR sensor(s) 1364 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1300. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1364 may be less susceptible to motion blur, vibration, and/or shock.

The vehicle may further include IMU sensor(s) 1366. The IMU sensor(s) 1366 may be located at a center of the rear axle of the vehicle 1300, in some examples. The IMU sensor(s) 1366 may include, for example and without limitation, an accelerometer(s), a magnetometer(s), a gyroscope(s), a magnetic compass(es), and/or other sensor types. In some examples, such as in six-axis applications, the IMU sensor(s) 1366 may include accelerometers and gyroscopes, while in nine-axis applications, the IMU sensor(s) 1366 may include accelerometers, gyroscopes, and magnetometers.

In some embodiments, the IMU sensor(s) 1366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1366 may enable the vehicle 1300 to estimate heading without requiring input from a magnetic sensor by directly observing and correlating the changes in velocity from GPS to the IMU sensor(s) 1366. In some examples, the IMU sensor(s) 1366 and the GNSS sensor(s) 1358 may be combined in a single integrated unit.

The vehicle may include microphone(s) 1396 placed in and/or around the vehicle 1300. The microphone(s) 1396 may be used for emergency vehicle detection and identification, among other things.

The vehicle may further include any number of camera types, including stereo camera(s) 1368, wide-view camera(s) 1370, infrared camera(s) 1372, surround camera(s) 1374, long-range and/or mid-range camera(s) 1398, and/or other camera types. The cameras may be used to capture image data around an entire periphery of the vehicle 1300. The types of cameras used depends on the embodiments and requirements for the vehicle 1300, and any combination of camera types may be used to provide the necessary coverage around the vehicle 1300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 13A and FIG. 13B.

The vehicle 1300 may further include vibration sensor(s) 1342. The vibration sensor(s) 1342 may measure vibrations of components of the vehicle, such as the axle(s). For example, changes in vibrations may indicate a change in road surfaces. In another example, when two or more vibration sensors 1342 are used, the differences between the vibrations may be used to determine friction or slippage of the road surface (e.g., when the difference in vibration is between a power-driven axle and a freely rotating axle).

The vehicle 1300 may further include an active suspension system 1343. The active suspension system 1343 can use the temporally consistent track heights 145 (e.g., the differences in heights 145) to minimize heave, pitch, and roll acceleration and control effort by controlling the suspension. The active suspension system 1343 can reduce the acceleration in a horizon window with respect to the current state, thus the active road profile may be less impactful. The temporally consistent track heights 145 can be used to adjust active suspension system 1343 in real time. For example, the active suspension system 1343 can control a suspension system to compensate for the temporally consistent track heights 145 (e.g., differences thereof) by adjusting one or more of a shock absorber, damper, spring, spindle, coil, joint, axle, struct, control arm, sway bar, a shock, a subframe, and so on according to the temporally consistent track heights 145.

The vehicle 1300 may include an ADAS system 1338. The ADAS system 1338 may include a SoC, in some examples. The ADAS system 1338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1360, LIDAR sensor(s) 1364, and/or a camera(s). The ACC systems may include longitudinal ACC and/or lateral ACC. Longitudinal ACC monitors and controls the distance to the vehicle immediately ahead of the vehicle 1300 and automatically adjust the vehicle speed to maintain a safe distance from vehicles ahead. Lateral ACC performs distance keeping, and advises the vehicle 1300 to change lanes when necessary. Lateral ACC is related to other ADAS applications such as LCA and CWS.

CACC uses information from other vehicles that may be received via the network interface 1324 and/or the wireless antenna(s) 1326 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1300), while the I2V communication concept provides information about traffic further ahead. CACC systems may include either or both I2V and V2V information sources. Given the information of the vehicles ahead of the vehicle 1300, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1300 if the vehicle 1300 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1360, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1300 is backing up. Some RCTW systems include AEB to ensure that the vehicle brakes are applied to avoid a crash. RCTW systems may use one or more rear-facing RADAR sensor(s) 1360, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1300, the vehicle 1300 itself must, in the case of conflicting results, decide whether to heed the result from a primary computer or a secondary computer (e.g., a first controller 1336 or a second controller 1336). For example, in some embodiments, the ADAS system 1338 may be a backup and/or secondary computer for providing perception information to a backup computer rationality module. The backup computer rationality monitor may run a redundant diverse software on hardware components to detect faults in perception and dynamic driving tasks. Outputs from the ADAS system 1338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1304.

In other examples, ADAS system 1338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1338 may be fed into the primary computer's perception block and/or the primary computer's dynamic driving task block. For example, if the ADAS system 1338 indicates a forward crash warning due to an object immediately ahead, the perception block may use this information when identifying objects. In other examples, the secondary computer may have its own neural network which is trained and thus reduces the risk of false positives, as described herein.

The vehicle 1300 may further include the infotainment SoC 1330 (e.g., an in-vehicle infotainment system (IVI)). Although illustrated and described as a SoC, the infotainment system may not be a SoC, and may include two or more discrete components. The infotainment SoC 1330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1300. For example, the infotainment SoC 1330 may radios, disk players, navigation systems, video players, USB and Bluetooth connectivity, carputers, in-car entertainment, Wi-Fi, steering wheel audio controls, hands free voice control, a heads-up display (HUD), an HMI display 1334, a telematics device, a control panel (e.g., for controlling and/or interacting with various components, features, and/or systems), and/or other components. The infotainment SoC 1330 may further be used to provide information (e.g., visual and/or audible) to a user(s) of the vehicle, such as information from the ADAS system 1338, autonomous driving information such as planned vehicle maneuvers, trajectories, surrounding environment information (e.g., intersection information, vehicle information, road information, etc.), and/or other information.

The infotainment SoC 1330 may include GPU functionality. The infotainment SoC 1330 may communicate over the bus 1302 (e.g., CAN bus, Ethernet, etc.) with other devices, systems, and/or components of the vehicle 1300. In some examples, the infotainment SoC 1330 may be coupled to a supervisory MCU such that the GPU of the infotainment system may perform some self-driving functions in the event that the primary controller(s) 1336 (e.g., the primary and/or backup computers of the vehicle 1300) fail. In such an example, the infotainment SoC 1330 may put the vehicle 1300 into a chauffeur to safe stop mode, as described herein.

The vehicle 1300 may further include an instrument cluster 1332 (e.g., a digital dash, an electronic instrument cluster, a digital instrument panel, etc.). The instrument cluster 1332 may include a controller and/or supercomputer (e.g., a discrete controller or supercomputer). The instrument cluster 1332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1330 and the instrument cluster 1332. In other words, the instrument cluster 1332 may be included as part of the infotainment SoC 1330, or vice versa.

FIG. 13D is a system diagram for communication between cloud-based server(s) and the example autonomous vehicle 1300 of FIG. 13A, in accordance with some embodiments of the present disclosure. The system 1376 may include server(s) 1378, network(s) 1390, and vehicles, including the vehicle 1300. The server(s) 1378 may include a plurality of GPUs 1384(A)-1384(H) (collectively referred to herein as GPUs 1384), PCIe switches 1382(A)-1382(H) (collectively referred to herein as PCIe switches 1382), and/or CPUs 1380(A)-1380(B) (collectively referred to herein as CPUs 1380). The GPUs 1384, the CPUs 1380, and the PCIe switches may be interconnected with high-speed interconnects such as, for example and without limitation, NVLink interfaces 1388 developed by NVIDIA and/or PCIe connections 1386. In some examples, the GPUs 1384 are connected via NVLink and/or NVSwitch SoC and the GPUs 1384 and the PCIe switches 1382 are connected via PCIe interconnects. Although eight GPUs 1384, two CPUs 1380, and two PCIe switches are illustrated, this is not intended to be limiting. Depending on the embodiment, each of the server(s) 1378 may include any number of GPUs 1384, CPUs 1380, and/or PCIe switches. For example, the server(s) 1378 may each include eight, sixteen, thirty-two, and/or more GPUs 1384.

The server(s) 1378 may receive, over the network(s) 1390 and from the vehicles, image data representative of images showing unexpected or changed road conditions, such as recently commenced road-work. The server(s) 1378 may transmit, over the network(s) 1390 and to the vehicles, neural networks 1392, updated neural networks 1392, and/or map information 1394, including information regarding traffic and road conditions. The updates to the map information 1394 may include updates for the HD map 1322, such as information regarding construction sites, potholes, detours, flooding, and/or other obstructions. In some examples, the neural networks 1392, the updated neural networks 1392, and/or the map information 1394 may have resulted from new training and/or experiences represented in data received from any number of vehicles in the environment, and/or based on training performed at a datacenter (e.g., using the server(s) 1378 and/or other servers).

The server(s) 1378 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1390, and/or the machine learning models may be used by the server(s) 1378 to remotely monitor the vehicles.

In some examples, the server(s) 1378 may receive data from the vehicles and apply the data to up-to-date real-time neural networks for real-time intelligent inferencing. The server(s) 1378 may include deep-learning supercomputers and/or dedicated AI computers powered by GPU(s) 1384, such as a DGX and DGX Station machines developed by NVIDIA. However, in some examples, the server(s) 1378 may include deep learning infrastructure that use only CPU-powered datacenters.

The deep-learning infrastructure of the server(s) 1378 may be capable of fast, real-time inferencing, and may use that capability to evaluate and verify the health of the processors, software, and/or associated hardware in the vehicle 1300. For example, the deep-learning infrastructure may receive periodic updates from the vehicle 1300, such as a sequence of images and/or objects that the vehicle 1300 has located in that sequence of images (e.g., via computer vision and/or other machine learning object classification techniques). The deep-learning infrastructure may run its own neural network to identify the objects and compare them with the objects identified by the vehicle 1300 and, if the results do not match and the infrastructure concludes that the AI in the vehicle 1300 is malfunctioning, the server(s) 1378 may transmit a signal to the vehicle 1300 instructing a fail-safe computer of the vehicle 1300 to assume control, notify the passengers, and complete a safe parking maneuver.

For inferencing, the server(s) 1378 may include the GPU(s) 1384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

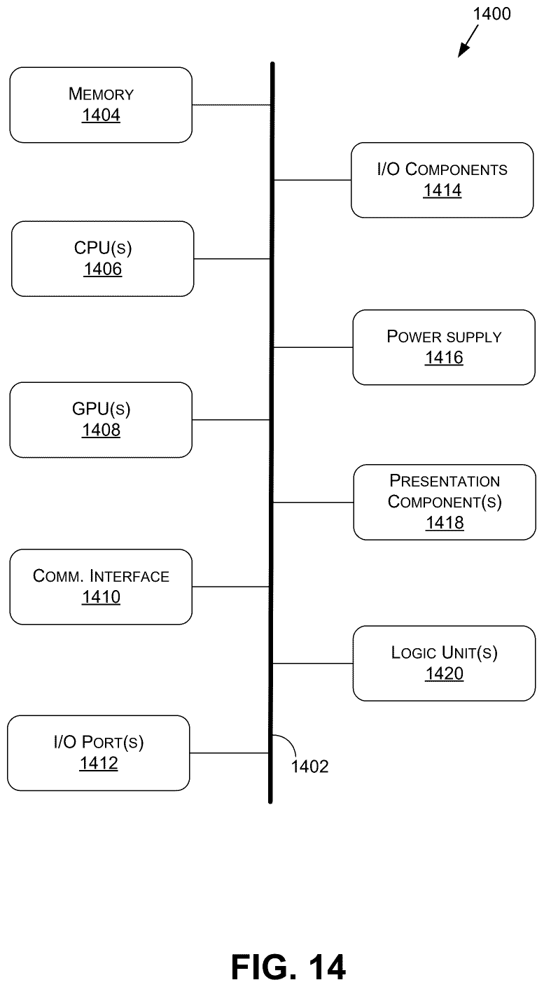

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

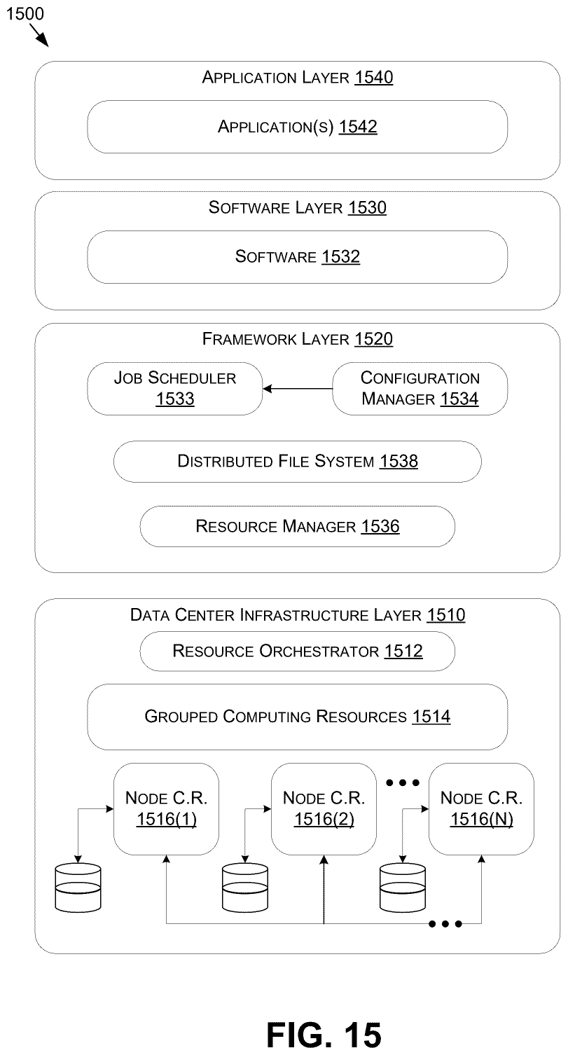

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (node C.R.s) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter Spark) that may utilize distributed file system 1538 for large-scale data processing (e.g., big data). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., big data).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items) or “subset,” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program including a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, includes multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (CPU) executes some of instructions while a graphics processing unit (GPU) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system including multiple devices that operate differently such that distributed computer system performs operations described herein and such that a single device does not perform all operations.

Use of any and all examples, or exemplary language (e.g., “such as) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities can be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising at least one processor to:
determine a disparity image for a plurality of frames by performing disparity estimation using at least a pair of images, the plurality of frames including a current frame and at least one previous frame;
determine track points of the ego vehicle;
determine first track point heights of the track points for each of the plurality of frames of the disparity image, the first track point heights including previous track point heights of the track points for each of the at least one previous frame of the plurality of frames of the disparity image and current track point heights of the track points for the current frame of the plurality of frames of the disparity image;
determine second track point heights by temporally fusing the current track point heights for the current frame and the previous track point heights for each of the at least one previous frame; and
perform one or more operations corresponding to the ego-vehicle based at least on the second track point heights.

2. The system of claim 1, wherein
the pair of images includes a rectified stereo pair comprising a left rectified image and a right rectified image;
the left rectified image is generated by rectifying a stereo raw left frame;
the right rectified image is generated by rectifying a stereo raw right frame; and
the output generated using a stereo camera that generates the pair of images comprises the stereo raw left frame and the stereo raw right frame.

3. The system of claim 1, wherein
the disparity estimation is performed using a neural network; and
the at least one processor is further to update the neural network using a disparity map determined using depth information from a plurality of spins of a light detection and ranging (LiDAR) sensor.

4. The system of claim 3, wherein the updating the neural network comprises:
accumulating the depth information from the plurality of spins of the LiDAR sensor;
determining a depth map using the depth information from the plurality of spins of the LiDAR sensor;
determining the disparity map using the depth map; and
updating the neural network using the disparity map.

5. The system of claim 4, the at least one processor further to:
determine second disparity image for a frame by performing, using the neural network, the disparity estimation using a second pair of images, wherein the second pair of images are obtained using output from a stereo camera of a second ego vehicle;
determine a loss of the second disparity image based on the disparity map; and
update one or more parameters of the neural network using the loss.

6. The system of claim 1, the at least one processor further to generate the track points using at least one of a wheel angle of the ego vehicle or a tire angle of the ego vehicle.

7. The system of claim 1, the at least one processor further to determine the first track point heights by:
constructing a region of interest (ROI) for each of the plurality of frames of the disparity image;
sampling a plurality of points within the ROI;
determining a homography matrix for the plurality of points;
determining a plane normal and a plane offset of the ego vehicle with respect to a ground plane; and
determining the first track point heights using the homography matrix.

8. The system of claim 7, wherein the ROI is generated at least one track defined using the track points.

9. The system of claim 7, wherein the plurality of points are sampled randomly within the ROI.

10. The system of claim 7, wherein the first track point heights are determined using a residual flow, the plane offset, and the disparity image.

11. The system of claim 1, the at least one processor further to temporally fuse the current track point heights and the previous track point heights by:
determining the track points of the ego vehicle for the current frame;
transforming the track points of the at least one previous frame into a coordinate system of the current frame;
fitting the first track point heights to a same plane;
determining the second track point heights using the fitted first track point heights; and
measuring the second track point heights against a virtual plane.

12. The system of claim 1, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing one or more deep learning operations;
a system for performing one or more simulation operations;
a system for generating or presenting virtual reality (VR) content, augmented reality (AR) content, or mixed reality (MR) content;
a system for performing one or more digital twin operations;
a system implemented using an edge device;
a system incorporating one or more virtual machines (VMs);
a system for generating synthetic data;
a system implemented at least partially in a data center;
a system for performing one or more conversational artificial intelligence (AI) operations;
a system for performing one or more generative AI operations;
a system implementing one or more language models;
a system implementing one or more large language models (LLMs);
a system for hosting one or more real-time streaming applications;
a system for performing light transport simulation;
a system for performing collaborative content creation for 3D assets; or
a system implemented at least partially using cloud computing resources.

13. A system comprising at least one processor to:
determine a disparity image for each of a plurality of frames by performing disparity estimation using a pair of images, the pair of images being obtained using a stereo camera of an ego vehicle, and the plurality of frames including a current frame and at least one previous frame;
determine first track point heights of the track points for each of the plurality of frames of the disparity image, the first track point heights including previous track point heights of track points for each of the at least one previous frame of the plurality of frames of the disparity image and current track point heights of the track points for the current frame of the plurality of frames of the disparity image;
determine second track point heights by temporally fusing the current track point heights for the current frame and the previous track point heights for each of the at least one previous frame; and
perform one or more operations associated with the ego vehicle based at least on the second track point heights.

14. The system of claim 13, wherein:
the disparity estimation is performed using a neural network; and
the at least one processor is further to update the neural network using a disparity map determined using depth information from a plurality of spins of a light detection and ranging (LiDAR) sensor.

15. The system of claim 14, wherein the updating the neural network comprises:
accumulating the depth information from the plurality of spins of the LiDAR sensor;
determining a depth map using the depth information from the plurality of spins of the LiDAR sensor;
determining the disparity map using the depth map; and
updating the neural network using the disparity map.

16. The system of claim 15, the at least one processor further to:
determine a second disparity image for a frame by performing, using the neural network, the disparity estimation using a second pair of images obtained using output from a second stereo camera of a second ego vehicle;
determine a loss of the second disparity image based on the disparity map; and
update the neural network using the loss.

17. The system of claim 13, the at least one processor further to determine the first track point heights by:
constructing a region of interest (ROI) for each of the plurality of frames of the disparity image;
sampling a plurality of points within the ROI;
determining homography matrix for the plurality of points;
determining a plane normal and a plane offset of the first ego vehicle with respect to a ground plane; and
determining the first track point heights using the homography matrix.

18. The system of claim 1, the at least one processor further to temporally fuse the current track point heights and the previous track point heights by:
determining the track points of the ego vehicle for the current frame;
transforming the track points of the at least one previous frame into a coordinate system of the current frame;
fitting the first track point heights to a same plane;
determining the second track point heights using the fitted first track point heights; and
measuring the second track point heights against a virtual plane.

19. The system of claim 13, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing one or more deep learning operations;
a system for performing one or more simulation operations;
a system for generating or presenting virtual reality (VR) content, augmented reality (AR) content, or mixed reality (MR) content;
a system for performing one or more digital twin operations;
a system implemented using an edge device;
a system incorporating one or more virtual machines (VMs);
a system for generating synthetic data;
a system implemented at least partially in a data center;
a system for performing one or more conversational artificial intelligence (AI) operations;
a system for performing one or more generative AI operations;
a system implementing one or more language models;
a system implementing one or more large language models (LLMs);
a system for hosting one or more real-time streaming applications;
a system for performing light transport simulation;
a system for performing collaborative content creation for 3D assets; or
a system implemented at least partially using cloud computing resources.

20. A method, comprising:
determining first track point heights of a ground surface for each of a plurality of frames of a disparity image based on a plane parallax algorithm, the first track point heights including previous track point heights of the ground surface for each of the at least one previous frame of the plurality of frames of the disparity image and current track point heights of the ground surface for the current frame of the plurality of frames of the disparity image; and
determining second track point heights by temporally fusing the current track point heights for the current frame and the previous track point heights for each of the at least one previous frame.
